(19) United States
(12) Patent Application Publication
(10) Pub. No.: US 2014/0074629 A1
(43) Pub. Date: Mar. 13, 2014

(54) METHOD AND SYSTEM FOR CUSTOMIZED, CONTEXTUAL, DYNAMIC & UNIFIED COMMUNICATION, ZERO CLICK ADVERTISEMENT, DYNAMIC E-COMMERCE AND PROSPECTIVE CUSTOMERS SEARCH ENGINE

(71) Applicant: Yogesh Chunilal Rathod, Mumbai (IN)

(72) Inventor: Yogesh Chunilal Rathod, Mumbai (IN)

(21) Appl. No.: 14/008,229

(22) PCT Filed: Mar. 29, 2011
(86) PCT No.: PCT/IB2011/051319

§ 371 Date: Nov. 21, 2013

(51) Int. Cl. G06Q 30/02

(52) U.S. Cl. CPC G06Q 30/0277
USPC 705/14.73

(57) ABSTRACT

A method and system for customized, contextual, dynamic & unified communication, zero click advertisement, dynamic e-commerce and prospective customers search engine is described. A method includes allow sender to dynamically associate one or more identified active links with active note (message) or with response of active note (message) and send or present said active note (message) or response of active note (message) with active link(s) to determined target receivers, wherein said active link(s) enables receivers to sell, purchase, transact, communicate, collaborate, search, share, workflow, provide response, participate in same activities as sender and access the active link(s) for message specific purpose in an integrated, contextual, customize and unified manner. A method further includes zero click advertisement in which each user's each message content matched with each advertisement content including keywords and ad targeting criteria and send message to advertiser or responder, wherein said message identifies target customers and charging advertiser based on receiving said message from identified target customers. A method further includes dynamic e-commerce in which an offer does not become valid until associate dynamic rules & conditions attained.

### COPYRIGHTS INFORMATION

A portion of the disclosure of this patent document contains material that is subject to copyright protection. The copyright owner has no objection to the facsimile reproduction by anyone of the patent document or the patent disclosure, as it appears in the Patent and Trademark Office patent file, but otherwise reserves all copyright rights whatsoever. The applicant acknowledges the respective rights of various Intellectual property owners.

### FIELD OF INVENTION

The present invention relates generally to customized, contextual, dynamic & unified communication, zero click advertisement, dynamic e-commerce and prospective customers search engine.

### BACKGROUND OF THE INVENTION

The internet provides a number of mechanisms that allow a user to find solution for particular problems. Search engines allow a user to search for web pages by using keywords or other criteria. A search engine typically uses algorithms to retrieve and order relevant results, such as web pages or other documents. Typically, a user of a search engine reads one or more of the document results, in order to determine the solution to a particular problem.

Many types of Social networks and communication systems are facilitating users for sharing, searching, communicating and solving some problems.

Answering system in which a user may submit a question. One or more people from an answering community may submit an answer to the question. Answers can be submitted over a period of hours or days. The user can return to the site hours or days after submitting a question to view the submitted answers.

All above method required lot of efforts and user have to use proper search keyword(s) or query or question and search method and sources for finding solution.

Presently user has to register with different web sites for different purposes including search engines, e-commerce web sites, social networking web sites, messaging and communication web sites and applications. Conventionally, a user can search, register web sites, subscribe services, install applications, share contents, and make payments by using plurality of sources for wide different varieties of user's requirements. Typically these sources are disparate and disorganized. In other words, the user must spend time researching, searching, registering, accessing, and identifying different sources that are not present in consolidated, coherent, unified and integrated manner. Often many of the sources are not relevant to user. What is needed is unified and integrated wide variety of communication system by providing and accessing message associate active links for solving user's on demand wide varieties of requirements.

Therefore, it is with respect to these considerations and others that the present invention has been made.

Tools are needed for creating unified and integrated environment in an abbreviated and user-friendly manner. A user may wish to reference other people, objects, and/or entities that exist on the social network and external of the social network when posting content. Conventional social network lack a content upload and delivery mechanism that enables users to easily refer to active links or objects and other users when posting content for the other users, where active link enables other user to access, view, transact, participate, communicate, collaborate.

E.g. User post question “<Question>” and attach Answer My Question application or active link with question and receiving user does not have to search, install application and register with service for providing answer. Receiving User can access question associate integrated application or active link for providing answer.

E.g. user post “I want to buy mobile” and plurality of responders provide response message with active links and user communicate with plurality of said responders and select one best that user like and make purchase transaction with selected responder. So user does not have to search plurality of mobile seller, register with different sites for communicate with different sellers and maintain profiles. So present system facilitates users to communicate, transact, workflow, access information & applications from plurality of sources in unified & integrated manner.

E.g. User post message with photo and attach active links (application features) view my photo, share my photo, which enables receiving user(s) to view photo, share photo with other connected users, wherein photo active link indicates user related accessible objects based on namespace and view my photo, share my photo active links indicates application features or components or objects that user can associate with message and enable receiving user to view & share photos. User doesn't have to install whole application, only part of features which sender user allow receiver user to access active links and associate operations on active link(s) of message.

No prior art provides on demand, customize, contextual, dynamic, unified and integrated environment for communication, collaboration, transaction, participation, sharing, providing response based on user defined message and associate active links indicating user's need, requirement, transaction, activities, workflow, task and like. User does not have to install plurality of applications, subscribe services, register with different applications, web sites and services, and maintain different profiles for different web sites & apps, searching content and media data from plurality of different sources. By using present invention user can access plurality of applications, services, objects from network base on message associate active links without departing from present network and user can share user data, application data, and profile with plurality of apps, services and users based on privacy settings.

Conventionally, advertiser can advertise in wide varieties of system in which advertisement present to user based on various methods and identifies prospective & target customers when user can click on advertisement and take one or more actions on advertisement. So all conventional all methods are indirect methods and non method suggests directly identifying prospective customers and target customers.

Present invention provides zero click advertisement method & system in which user or prospective customers can send message for buying something and system identifies target customers based on prospective customer's message and real time inform matched advertisers for responding to said message of prospective customers and helps in identifying the target customers. Each user's each message content matched with each advertisement content including keywords and ad targeting criteria and send message to advertiser or responder, wherein said message identifies target customers and charging advertiser based on receiving said message from identified target customers. Thus present invention suggest directly identifying prospective & target customers for advertisers based on user's active note (message) including message related to buying particular products and services.

Conventionally, e-commerce web sites and system are not provide solution for dynamically change buying and selling rules & conditions in which an offer does not become valid until associate dynamic rules & conditions attained. So present invention provides dynamic e-commerce in which an offer does not become valid until associate dynamic rules & conditions attained.

### OBJECT OF THE INVENTION

The principal object of the present invention is to provide customized, contextual, dynamic & unified communication and allow sender user to dynamically associate one or more identified active links which are controlled by user and exist in social network with message and sent to determined target users, wherein said active link(s) with message enables receiving user to sell, purchase, transact, participate with same activities as sender user, communicate, collaborate, workflow with sender user, provide response in an integrated, dynamic and unified manner. Central unit stores each active links associate user actions and data for enabling users to share said data with other apps, services and users.

Another object of invention is to monitor, track, store, index & rank each user actions on said each message associate each active link and making them searchable for other users which enable users to get relevant results. E.g. Many users action is [Users] buys from merchant [ABC] for mobile [XYZ] indicates more relevant for search query “mobile” and rank prior to other search results.

Another object of invention is to provide zero click advertisement based on posted messages in which each user's each message content matched with each advertisement content including keywords and ad targeting criteria and send message to advertiser or responder, wherein said message identifies target customers and charging advertiser based on receiving said message from identified target customers.

Another object of invention is to provide prospective customers search engine based on posted messages.

Another object of invention is to provide dynamic e-commerce platform to users in which an offer does not become valid until associate dynamic rules & conditions attained.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” an item, such as a request, response, or other message, from a device or component includes receiving the message indirectly, such as when forwarded by one or more other devices or components. Similarly, “sending” an item to a device or component includes sending the item indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards providing users with customized, contextual, dynamic & unified communication, zero click advertisement, dynamic e-commerce and prospective customers search engine system. Mechanisms of the invention may enable a user to post message with active links, wherein said active links enables receiver and/or responder to communicate & collaborate with sender, provide response(s) & service(s) to sender, enabling workflow, e-commerce transaction, participate with sender's one or more activities and access active links. A method further includes zero click advertisement in which each user's each message content matched with each advertisement content including keywords and ad targeting criteria and send message to advertiser or responder, wherein said message identifies target customers and charging advertiser based on receiving said message from identified target customers. A method further includes dynamic e-commerce in which an offer does not become valid until associate dynamic rules & conditions attained. A server may receives, stores, indexes and process each said message with active links from each registered user and present to target one or more responders, subscribers, selected, matched and connected users.

Moreover, the present invention makes use of the following terms, definitions, acronyms, and abbreviations for describing the invention:

Active Note:

Active note is a message with active links provided or posted by user or automatically generated and/or sends by system to one or more receivers and/or responders for receiving purpose specific response(s), wherein said active link(s) enables receivers or responders to sell, purchase, transact, communicate, collaborate, search, share, workflow, provide response, participate in same activities as sender and access the active link(s) for message specific purpose in an integrated, contextual, customize and unified manner.

Active Link(s):

Active link is a link of one or more applications, services, objects, multi AI agents, multimedia data & contents, people, networks, groups, links or URLs, ID, user Profiles, profile objects, pages, attachments, informational links, shared workspaces which are available or invoked from networks and/or from external domains, applications, networks, services and devices with one or more associate data. User can create and update one or more categories lists of identified active links which are controlled by user and exist in and manage by social network based on user selection, uploaded by user, search & match, suggested & provided by connected & matched users, suggested list or auto generated by central unit based on user profiles, user data, user activities, recorded user's actions, past responses, interest, list of active links, list of active links of connected users, installed applications and provided by 3^{rd} parties developers, service providers and advertisers based on users privacy settings and preferences. Sender can search, select, identify and manually attach or auto attach one or more active links with said active note (message) or response of active note (message), wherein said one or more attached active links enables receivers and/or responders to provide one or more responses & actions, communicate, collaborate, answer, share, search, workflow, take one or more actions, transact, e-commerce, social networking and participating activities of sender of message. Associate data of active link comprising URL or namespace of each active link for identifying and allowing to access active link associate objects, applications, services, media data, people, entities, identities, profile, group, network, page & other objects of network, active link related one or more metadata, categories, keywords, sources, providers, details, descriptions, properties, links, attachments, features, upload, created & use date & time, help, identifier & profile(s) of sender & receiver of active link, active link associate tracking status & status, active link associate object related user data and preferences, security policies, authentication information and privacy settings of accessing & sharing active link and active link associate object(s) related user data.

Active Note(s) Responder:

Active note related to particular purpose, for example if user want to sell something send active note with active link for sell something and receiver users can access active link for purchase products or services directly or if user want to buy particular brand, user send active note to one or more responders and responder can associate one or more active links with response(s), so response receiver can buy products or services directly via accessing active links.

Lifestream:

Lifestream comprising user related chronological stream of categories all digital resources provided & generated by user, connected users and auto generated, auto identified, auto detected, auto sensed user related resources based on user's activities, actions, events, current locations, transactions, extracted from recorded video, sensed by sensors. Lifestream includes all categories active note(s) and associated one or more ranked responses & actions which are used or executed or best matched or preferred or selected or implemented or tried or liked or selected and satisfied to the user or selected & successfully implemented by user or choose, buy or purchase or subscribed by user including any branded or un-branded products and services, solve the user's problem(s), provides right direction or help to the user for any types of important action(s), activities, act(s), deed(s), behavior, steps, before doing, buying, subscribing, selecting, experimenting something, before going, traveling, migrating somewhere, how to do something, purpose, event, pursuit, search, match making, tracking, alerts, matter, affair, question, puzzle, doings, hobby, difficulty, trouble, struggle, decision, subject, topic, thing, problem, issue, interest, procedure(s), task(s), job(s), pastime, work(s), service(s), professional(s), occupation, business, manufacturing, processing, diversion change, alteration, transformation, shift, migration, career, goal, plan, project, target, consulting, situation, duty, mission, responsibility, function, construction, deal, transaction, arrangement, matter, operation, contract, undertaking, enterprise, scheme, development, exercises, assignment, obligation, industry, selling, marketing, production, company, firm, organization, establishment, news, travels, health, education, finance and like. Life stream covers all chronological user generated or created or provided or updated active note(s) with metadata including taxonomy categories, date & time, rank, review notes or comments and like.

User Actions:

Central unit can identifying, storing, ranking, processing & presenting one or more user defined and system generated actions on each active note (message), related responses, communications, sharing, collaboration, searching and associate active links based on monitoring, recording, logging of user actions & activities and one or more filters & privacy settings with action date & time, action categories, user provided or auto recorded action related details, action related response & message, one or more action source(s) including people, applications, services, shared workspace, media data or contents, objects, groups, networks, pages, items, links and any action related identified objects from network and/or external domains, attachments, lists, tracking status, further communication details, ratings or ranks, comments and user provided and/or dynamically associated one more active links, services, objects, media data, shared workspaces and applications.

Zero Click Advertisement:

In Zero click advertisement each user's each message content matched with each advertisement content including keywords and ad targeting criteria and send message to advertiser or responder, wherein said message identifies target customers and charging advertiser based on receiving said message from identified target customers.

Dynamic e-Commerce:

In dynamic e-commerce an offer does not become valid until associate dynamic rules & conditions attained.

Custom Commands & Search Syntax:

User can use one or more or group(s) or combinations or series or sequence of custom commands & syntax or command templates or scripts with active note(s), response(s) of active note(s) and/or search operators and parameters for searching, matching, two way matching, selecting, filtering, subscribing, mapping, downloading, accessing, invoking, programming, book marking, attaching, detaching, assigning, federating, aggregating, integrating, distributing, collaborating & communicating, composing, comparing, co-coordinating, orchestrating, choreographing, organizing, recording, configuring or customizing, classifying & grouping, connecting, disconnecting, removing, adding, alternating or changing or modifying, updating, replicating or synchronizing, transacting, binding with 3rd party applications, networks, services & devices, routing or redirecting, forwarding, transferring, merging, joining, listing, linking, arranging, scheduling, automating, sequencing and ordering as per workflow & rule based, collecting, receiving, managing, monitoring, registering, accounting & metering, reporting, logging and executing one or more or group or combinations or series or sequences of active notes, active notes senders, active notes response providers, responses, communications, active note or response associate active links, active link related objects & objects data, contents from database(s) and service applications from plurality of sources via command scripting language and integrate with any 3^{rd} parties applications, services, devices and networks via web services, APIs, SDK, plug-ins, plug & play and any programming & scripting languages.

User can also use one or more or combinations of search Boolean operators including AND (+), OR, NOT (−), Phrases, multiple brackets for multiple inner searches, domain specific semantic and ontology syntax and parameters including one or more domain(s) list, active note senders or providers list, active note response providers list, service(s) name list, source(s) type, taxonomy categories or classification(s) or cluster(s) list, service type(s) including free or paid or sponsored, preferences including bookmark or save results or export results, rank & hits range, data range, language(s) list, location(s) list, safe search, two way match making preferences, set number of results per page & search up to number of depth(s) of sources, apply one or more filter(s) including ALL, EXACT, ANY, NONE words and one or more or combination of sorting type(s) including ascending & descending order, rank wise, category wise, date & time wise, hit wise, location wise, language wise, availability status wise, price wise (free or paid) with one or more search or command syntax string(s).

User can also concurrently searching for one or more or multiple search string(s) of one or more or multiple fields or categories or taxonomy classifications or clusters and each search results presented in one or more pages via categories tabbed interfaces and each result of each said search results comprising source URL or profile link, full or partial or abstract of contents, messages, active notes, responses of active notes, resource, data, source details & URL, category, date & time, ranks & reviews, hit statistics, online status, subscription status, metadata & properties and sorting as per date & time, source, rank, hits, location, language, status and ascending & descending order and presenting individually or in one or more categories group or filtering and user can select one or more search result of said one or more search results related to said one or more search strings and take one or more group actions on said selected one or more search result(s) including bookmarking, filtering, comparing, sorting & ordering, saving, subscribing, un-subscribing, inviting for subscriptions, blocking sources, send messages.

Taxonomy Wise Active Note(s) Project Management:

User can use project management and workspace for managing plurality of active note(s), requests, communications, messaging with plurality of known as well as unknown responder of active notes for responses including searching, matching, book marking, subscribing, attaching, detaching, assigning, federating, planning, aggregating, integrating, distributing, collaborating & communicating, composing, comparing, co-coordinating, orchestrating, classifying & grouping, connecting, disconnecting, removing, adding, alternating or changing or modifying, testing or trialing, updating & upgrading, replicating or synchronizing, transacting, ranking & grading, analyzing, invoking, mapping, binding with 3^{rd} party applications, networks, services & devices, filtering, routing or redirecting, forwarding, transferring, merging, joining, listing, linking, arranging, scheduling, automating, sequencing and ordering as per workflow & rule based, choreographing, organizing, recording, configuring or customizing, collecting, receiving, selecting, assigning, managing or administrating, monitoring, programming, registering, certifying, accounting & metering, reporting, logging and subscribing plurality of services of active note responders or response providers or service providers and said project management and workspace & workflow works in multiple users & accounts, multiple messaging to multiple users, multiple remote users, multiple roles or rights & privileges, multiple members, multiple administrators levels, multiple communication clients or applications or services or networks or devices, multiple communication & collaboration channels, multiple scaling and multiple interface styles modes.

In an embodiment, customize, contextual, dynamic, unified and integrated communication comprising:
allow sender to determine target receivers;
allow sender to dynamically associate one or more identified active links with active note (message) or with response of active note (message), wherein response based on at least part of active note (message);
allow sender to send or post said active note (message) or response of active note (message) with active link(s) to determined target receivers, wherein said active link(s) enables receivers to sell, purchase, transact, communicate, collaborate, search, share, workflow, provide response, participate in same activities as sender and access the active link(s) for message specific purpose in an integrated, contextual, customize and unified manner;
receiving and processing said active note (message) or response of active note (message) at the central unit; and
presenting said active note (message) or response of active note (message) to determined target receivers as per preferences & privacy settings.

In an embodiment, sending, receiving & processing active note (message) and associate response of active note (message) in a network comprising steps of:
determine one or more target receivers and/or responders by sender and/or auto determined by central unit;
sending active note (message) with or without dynamically attaching one or more identified active links by sender and/or auto attaching by central unit to one or more determined target receivers and/or responders, wherein said active links enables receiver and/or responder to communicate & collaborate with sender, provide response(s) & service(s) to sender, enabling workflow, e-commerce transaction, participate with sender's one or more activities and access active links;
receiving and processing said active note (message) at the central unit;
presenting said active note (message) to one or more target receivers and/or responders based on one or more preferences;
allow each said responders to send one or more responses for said active note (message) to sender of active note (message) with or without attaching one or more active links and/or auto attaching active links by central unit, wherein said active links enables receiver of response(s) to communicate & collaborate with responder, send active note (message), receive services, enabling workflow, participate with responder(s), make purchase transaction, e-commerce, view, share & search multimedia data & contents, solve any active note (message) specific solution and access active links;
allow user to take one or more actions on said active note (message) and/or related responses and/or associate active links;
identifying, monitoring, storing, recording, logging said one or more user actions based on one or more filters & privacy settings with action date & time, action categories, user provided or auto recorded action related details, action related data, responses & communications, one or more action source(s) including people, applications, services, shared workspace, media data or contents, objects, groups, networks, pages, items, links and any action related identified objects from network and/or external domains, attachments, lists, tracking status, further communication details, ratings or ranks, comments and user provided and/or dynamically associated one more active links, services, objects, media data, shared workspaces and applications; and
receiving, storing, indexing, ranking, processing said message, message related responses and actions & action associate logged data for making them searchable for other users and/or send to subscribers or connected users of user based on sender & receiver user's privacy settings & preferences, wherein action associate said active links enable said one or more receiver users to participate with sender user.

In an embodiment, processing an active note(s) and associate concept(s) comprising steps of:
receiving and processing the active note (message) from the active note provider(s) or sender;
determining one or more target responders or receivers;
presenting or sending a representation of the active note (message) to one or more target responder(s) or receiver(s);
receiving and processing one or more multidimensional concept(s) and/or response(s) from one or more target responders or receivers; and
presenting or sending the multidimensional concept(s) and/or response(s) to the active note provider(s) or sender as per preferences.
selecting one or more concept(s);
send one or more concept with active note to related responder(s) and
receiving one or more response(s) from one or more responder(s) based on selected each concept(s) and related active note(s).

In an embodiment, managing active links comprising steps of:
registering each user and storing each user's profile, connections and privacy settings;
registering and storing one or more active links and profile & metadata of active links by user, application & service providers and central unit;
maintaining in a database a plurality of said active links;
maintaining in a database each user related active links;
allow user to associate or attach one or more active links with message from said active links;
send message to determined one or more targeted receivers;
allow targeted receivers to access said active links or provide response and attaching one or more active link(s) with said response based on at least part of message;
allow user to take one or more actions on said message associate one or more active links and track one or more user actions on said message associate one or more active links; and
storing each message associate one or more active links with said tracked user actions on said message associate one or more active links.

In an embodiment, managing nodes and connections among nodes in a network comprising steps of:
maintaining in a database a plurality of nodes of a social graph;
maintaining in a database a plurality of connections in the social graph, where each connection represents a connection between two or more nodes in the social graph;
maintaining in a database information about one or more of the nodes and connections;
providing an interface for users of the social network to send content items in one or more communication channels of the social network to determined one or more target receivers and/or responders;
receiving via the interface a said content item from a user of the social network, the said content item including a link referencing a node of the social graph; and
sending or presenting said content items in one or more communication channels of the social network to determined one or more target receivers and/or responders;
allow receivers and/or responders to send content items to sender of content items in response to received said content items including a link referencing a node of the social graph, wherein said referred links based on at least part of received content items;
tracking user actions on said link referencing a node of the social graph; and
receiving, storing, indexing, ranking, mapping, processing said content items, associate one or more links referencing a node(s) of the social graph and related one or more tracked user actions.

In an embodiment, generating an active note, the method comprising steps of:
allow user to filter pre-defined & pre-categories activities, actions, events, and transactions types;
monitoring a plurality of activities, actions, events, transactions of each user, said each user configurable to act as sender user and a receiver or responder user;
storing a plurality of said activities, actions, events, transactions in a data repository unit;
determine one or more target receivers and/or responders by user and/or auto determined by central unit;
generating a plurality of active notes or messages regarding one or more of the activities, actions, events, transactions of each user with or without associating one or more active links with said active note(s) or message(s), wherein said active links enable receiver or responder users to communicate & collaborate with sender, access active links, provide response(s) & service(s) to sender, enabling workflow, e-commerce transaction and participate in at least one of the activities as performed by the sender;
filtering plurality of active notes for one or more determined receiver or responder users; and
presenting one or more active notes or messages to said determined target receivers or responders.

In an embodiment, communication in a network(s) environment comprising steps of:
allowing each user to subscribe to each other user for receiving each active note (message) of sender or publisher;
receiving and storing one or more user profiles, preferences, active note (message) subscribers, active note (message) subscriptions, dynamic relationships & connections, selections and privacy settings for sending and receiving active notes (messages) and communication at a central unit;
determining one or more target subscribers by a sender;
allowing the sender to send each active note (message) to the one or more target subscribers via a central unit;
receiving each active note (message) with or without associated with one or more active links from the sender or publisher at the central unit, wherein said active links enables subscribers to access active links, communicate, provide response(s) & service(s), workflow, e-commerce transaction, participate with sender's one or more activities;
storing, indexing and processing said each active note (message) with or without auto attaching one or more active links at the central unit wherein said active links enables subscribers to communicate, provide response(s) & service(s), workflow, e-commerce transaction, participate with sender's one or more activities;
determining one or more target subscribers by the central unit based on one or more preferences and subscriptions;
sending a representation of the each active note (message) to the one or more target subscribers by the central unit;
presenting each active note (message) in chronological order based on the preferences and privacy settings, subscriptions of target subscriber by the central unit; and
receiving, storing, indexing, ranking and processing said each public active note (message), related responses, active links & user actions for making the searchable for users and allow to search & subscribe source of active note (message) publication based on at least part of message content and one or more predetermined criteria.

In an embodiment, communicating in a social network about active notes and/or activities or actions from an external domain comprising steps of:
maintaining a profile for a plurality of users of the social network, each profile comprising profile data, privacy settings and connections to each of a plurality of other users of the social network;
determine one or more target receivers and/or responders by user and/or auto determined by central unit;
receiving a plurality of user posted active notes with or without attaching one or more active links by user and/or auto attaching by central unit from the external domain, each active notes representing user posted active note or an action taken by a user of the social network in the external domain, wherein said active links enables receiver and/or responder to access active links, communicate, provide response(s) & service(s), workflow, e-commerce transaction, participate with sender's one or more activities;
receiving & processing said active notes and/or logging or recording the actions at the social network, each logged action including information about the action; and
generating one or more messages wherein each of said messages represents one or more of said recorded actions; and
presenting said active note(s) and/or generated messages to each determined target receivers and/or responders.

In an embodiment, dynamically creating groups for active note(s), related responses, communication in a network environment, the method comprising steps of:
receiving and storing users profiles, real time location information of users, preferences, connections, selections, privacy settings at the central unit;
determining one or more users for dynamically created or user created & updated one or more groups based on active note(s), related responses, active links & user actions and associate categories, keywords & metadata, match making of users preferences, real time location information based on wireless devices and wired devices, date & time, online availability of users, bookmarked active note providers or responders, one or more accepted invitations, permissions for joining the group, conditions, searching & matching, selected connections, subscriptions & selections of users, privacy settings, user profiles & data, interest & activity types, filters and any combinations thereof and/or based on one or more users auto match by the central unit;
allowing members of said one or more groups to post active notes, provide & receive responses, attach and access active links, establish communication, create social network(s), provide service(s), collaborate, bookmark, rank, search and share multimedia contents.

In one embodiment, present invention provides a system and method of processing an active note(s) from an active note provider(s) and related response from responder(s) comprising steps of:
receiving and processing the active note(s) from the active note provider(s);
determining one or more target responders;
presenting or sending a representation of the active note(s) to one or more target responder(s);
receiving and processing a response from one or more target responders; and
presenting or sending the response to the active note provider(s) as per preferences.

In one embodiment, displaying active notes, related responses, active links and user actions in a social network, the method comprising steps of:
receiving by a social network a plurality of active notes, related responses, active links and user actions from users of the social network;
providing a user interface to a user of the social network;
displaying in the user interface some of the active notes, related responses, active links and user actions received from users in the social network;
providing to the user one or more selectable filters, each filter specifying a criteria to be applied to the active notes, related responses, active links and user actions;
receiving a selection of a filter from the user; and
updating or presenting said active notes, related responses, active links and user actions based on the said received selected filter and presenting said one or more updated active notes, related responses, active links and user actions.

In one embodiment, managing unified communications and collaboration for one or more active notes, the method comprising steps of:
receiving from one or more users of a social network a request to initiate a new communication for one or more active notes;
initiating a plurality of new communications responsive to the requests,
for each of a plurality of the communications, receiving requests from one or more users of the social network to join the communications;
attaching users to the communications responsive to the requests to join;
receiving active notes, related responses, active links, user actions & communication data from a plurality of the users in connection with one or more of the active notes related communications,
for each communication, presenting to each member of said communication the plurality of active notes, related responses, active links, user actions & communication data received for the communication in a tree style or format based on one or more preferences and privacy settings.

Present invention can solve users all requirements in one source in an integrated, collaborative and unified ways by using plurality of responders, active links, applications, services, objects, advertisements and media data or contents.

In one embodiment, central unit maintains for each of plurality of users of network(s), a user account(s) including verified and/or anonymous or general, one or more public, private & shared profile(s) including one or more active note providers and responders' profiles & service profiles, preferences & privacy settings and set of connections with other users of the network(s), wherein allowing users or active note(s) provider(s) and responders to creating and updating connections list(s) based on contacts, invitations, finding people from internal or external networks, searching & matching, subscribers, book marks and match making preferences.

In one embodiment, Life stream Management facilitates active note provider and life stream administrator to manage and update life stream timeline related note(s) & related resources with metadata including multimedia contents, text, messages, emails, communications, web links, videos, images, photos, albums, graphics, audio, voice, files, scanned documents, databases and related applications & services, connections, updated resources from connected users or internal or external sources & services, user's or connected users' generated contents like publications, blogs, news, events, updates, notes, experiences, reviews, discussion, likes & dislikes, activities, solutions, sharing, purchases, brands use and want to use, history and everything related to user's and connected users' activities or life, wherein said metadata comprising date & time, one or more taxonomies, ontology, categories, semantic syntax, keyword(s), comments, source, author.

In one embodiment, User can associate one or more taxonomies to said life stream for organizing life stream comprising allowing user or active note(s) provider(s) to download or synchronize or update one or more default top level or parent system taxonomies from the central unit and allow user to append or update one or more user created taxonomies of one or more levels to said default top levels or main system taxonomies.

In one embodiment, allowing user to share or publish or subscribe or synchronize one or more selected and updated life stream or selected one or more active note(s) and related multidimensional active resources & actions of life stream to or with one or more selected or connected or matched users or subscribers based on one or more conditions, privacy settings and preferences.

Active note can comprising one or more statement(s) or sentence(s), templates, selected or edited concepts, note taking methods including tree structure, charting, outlining, mapping, mind maps, timelines, unstructured notes, structured notes with customize fields or tags, details, visual notes, flow charts, cluster notes, reports, summary, story, blog, descriptions, database, message(s), paper form, multimedia content types including text, image(s), photos, symbols, diagram, presentation, video(s), extracts or part of video &, voice, map, scanned documents, calendar, script, query, keyword(s) in one or more languages, phrase(s), Boolean operators, rules, condition(s), semantic syntax, ontology with associated one or more accessible metadata or fields.

In one embodiment, active note provider can identify or select or extract one or more active note(s) from existing note(s) of life stream and/or based on received one or more concepts or searching or subscribing & selecting of active note(s) from active note(s) of other users or drafting or preparing new active note(s) or sub active note(s) with one or more accessible metadata or fields.

Central unit can auto generating, storing or recording one or more note(s) or active note(s) attached with one or more accessible metadata or fields based on monitoring, tracking, sensing, auto detecting, auto identifying, storing and managing of one or more related or filtered activities, actions, events and transactions of active note provider(s) or related & connected users as per preferences and privacy settings.

one or more said accessible metadata or fields associate with active note(s) comprising one or more determined responders & preferences, date & time, title, priority types including high, normal, low, expiration date & time, keywords, categories, types, taxonomies, ontologies, source & categories of activities, actions, events, transaction, source of note, location(s), language type, size, source id, source profile(s), privacy settings & preferences, dynamically attached one or more active links, informational links, attachments, multimedia contents, applications and service including communication utilities and shared workspace for providing response or multidimensional active resources & actions, collaboration, participation, tracking, answering, communication, workflow, services & task fulfillment, searching, sharing, social networking, purchasing, transactions, information.

System can auto update said auto generate note(s) to the user's life stream timeline or auto synchronizing and presenting identified active note(s) to related or connected or matched or subscribed responders as per preferences and privacy settings.

Active note(s) provider or responder(s) comprises of one or more digital automated sources including mobile, computer, video camera(s), scanner, digital pen & pad, RFID, touch screen, speech & text recognition system, communication systems, note taking software, imports from other systems, applications, services, devices and networks, multimedia content sources including image, video, file, extracts from video or voice, editor, wizard, search engine, survey, historical data, logs, sensor systems, multi Artificial Intelligence Agent(s), languages & translation system, speech or voice source(s) & paper forms, users of social network(s), human mind, experts, user's related groups, connections, subscribers, 3^{rd} parties and like minded users and one or more individuals, groups, collaboration of one or more pre-identified individuals comprising company, organization, professional and social bodies, web site, governmental bodies and enterprises, service providers, data and application providers and 3^{rd} parties providers on behalf of animals, birds, non living things including tree, products, road, building, location, tourist place.

Active note(s) may related to any types of activities, concepts, purpose, updated status, thought, motive, logic, act, idea, what user currently doing or want to do or already did something, aim, goal, desire, want, wish, requirement, request, query, help, object, matter, plan, target, task, issue, subject, topic, project, case, event, problem, attempt, try, what next possibly user can do, what happen next, likes & dislikes, hobby, selection or choice, around anything related to user's or entity's environment like brands & services using, brands & services want to use, before spent money, experiences, reviews, interest, relation, connected people, all types of works, activities, actions, jobs, procedures, to do, about user, user's life, health, education, travel, entertainment, life style, finance, job, business, career, learning, training, food, habit, hobby, location and like.

In one embodiment, central unit can dynamically creates one or more groups of active note(s) providers and/or responders for collaboration and communication based on one or more active notes and/or concepts and/or responses and related metadata, keywords, categories, location, availability, date & time, language, invitation, relations or connections, subscriptions, searching & matching, preferences and profile data of active note(s) providers and responders.

Central unit can receives and processes said one or more active note(s) and/or selected concepts from one or more active note(s) providers, wherein said processing comprising storing, updating, indexing, validating & formatting including editing, clarifying, update details, fonts settings, spell checking, language & spam detecting, translating, transcribing, converting to other formats like voice, text, associating priority types including high, normal, low, expiration, date & time, categories, keywords, locations, advertisements, payment information, profile data, URL, dynamically attaching one or more system data, active links, informational links, attachments, multimedia contents, applications and service including communication utilities and shared workspace for providing response or multidimensional active resources & actions, collaboration, participation, tracking, answering, communication, workflow, services & task fulfillment, searching, sharing, social networking, purchasing, transactions, information and determining one or more responders for sending or routing or publishing said active note(s) to one or more determined responders.

Central unit can comprising server or processor or device linked to internet, intranet, peer to peer network including super nodes or hubs, LAN, WAN, mobile service provider(s), cluster of centralized or distributed servers, database(s) and one or more types of networks.

In one embodiment, determining of one or more target responders by central unit and/or active note provider(s) based on one or more preferences, privacy settings, active note related dynamic selections, auto match option, selected concepts, connections, subscriptions, filters, rules or conditions, profiles, ranks, points, historical data, behavior, interests of active note provider, availability, ranks, preferences & privacy settings, service(s) profile(s) or personal profile(s) data, provided concepts and determined active note(s) providers of responders, active note(s) associated one or more categories, keywords, location & metadata and auto matching or searching by central unit based on one or more predetermined preferences or criteria of active note providers(s) and/or responder(s), determined relevancy criteria and number of determined responders.

In one embodiment, central unit can registering one or more responders for providing one or more concepts and/or response(s) or multidimensional active resources & actions services to one or more active note providers for one or more types of active note(s) with service profile, wherein said service profile comprising service details, categories, keywords, location, language, expertise, subject or domains, availability or date & timings, payment information, conditions or rules, privacy settings, preferences, one or more associated connections and subscription lists.

In one embodiment, determining receiving one or more related active note(s) from one or more active note(s) provider(s) by responder(s) based on one or more subscriptions, services, connections, selections, preferences, privacy settings, profile(s) data, relations, collaboration with other responders or service providers, assignments by other connected users or service providers, filters, rules or conditions, locations, languages, timings or availability, payment information, ranks, points, historical data, behavior, interests, searching and/or subscribing active note(s) provider(s) based on one or more search criteria, relevancy and auto matching criteria.

One or more target responders receiving and processing said one or more active note(s) and/or selected concepts from one or more active note(s) providers from one or more networks, wherein said processing comprising storing, indexing, formatting including editing & updating, clarifying, assign ranks, comments, status & tracking status, identifying & searching resources utilized for providing response(s) or multidimensional active resources & actions, determining, sending & clarifying one or more concepts, preparing one or more concepts specific one or more responses or multidimensional active resources & actions and associate one or more accessible metadata or fields with active note(s).

In one embodiment, identifying & searching resources utilized for producing or providing response from local, central unit, service providers and connected users based on keyword(s) contained in the active note(s) and related metadata, active note provider data including profile, historical data, life stream data; and presenting, sharing, synchronizing, updating and displaying the said identified resource to said responder(s) for preparing or providing response(s).

In one embodiment, determining, sending & clarifying one or more concepts based on an analysis of the active note(s) by responder(s) comprising determining the one or more concept(s) based on analysis of the active note(s), life stream environment analysis and clarifying active note(s) with active note(s) provider(s) based on one or more communication, active note(s) provider's one or more categories or part(s) of life stream, past active note(s) & related ranked used multidimensional active resources & actions, active note provider's one or more profile(s), preferences, rank, points & levels, purchase transactions & e-commerce history, current location, connected users information and sending or clarifying one or more determined concepts or multidimensional views to related active note(s) provider(s) for providing one or more response(s).

The system & method can allow active note(s) provider(s) or responders to search one or more active note(s) and/or concept specific one or more active resources & actions based on one or more concepts, search criteria, keyword(s), categories, taxonomies, ontology, semantic syntax, conditions, rules from local and/or online central server and/or external sources & services integrated by API and/or connected social or personal networks or from any selected connections.

Responder(s) can preparing or drafting response(s) or multidimensional active resources & actions based on one or more concepts, experience, analysis, one or more sources including search local & central database, online search engines & resources, social networks, 3rd parties databases, books, resources from connected users, collaboration of responders and service providers, by using one or more applications, services & devices from one or more networks.

Response(s) or multidimensional active resources & actions comprises any types of resources and one or more multimedia contents including text, messages, emails, communications, web links, connections, videos, images, photos, albums, graphics, audio, voice, files, scanned documents, databases, applications, services, updated resources from internal or external sources, user generated contents or services from connected or subscribed or matched users including search results, articles, publications, blogs, news, events, experiences, reviews, discussion, actions, sharing, suggested brands, providing one or more concept(s) specific suggested resources & action(s) including one or more actions, what to do, better way to do, more ways, questions & related answers, answers, suggestions, solutions, guidance, helps, finance, supplies, information, knowledge, tips & tricks, training, learning, match making, ideas, what, where, when, why and how like information, one or more actions, suggestions, solution, direction, guidance, execution plan, step by step procedures, to do, tips & tricks, more particularly, but not exclusively to using a community to provides personalized or customized multi model or multidimensional active resources & actions for active note(s), result-oriented actions, positive steps, active resources designed to actively promote and advance the user's status, any measures taken to rectify conditions, acts or deeds used to remedy a situation, solution for removing an error, or adjust a condition, how to carry out a task, how to execute the things, planned series of actions, tasks or steps designed to achieve an objective or goal, guide the implementation or improvements of any types of process including task assignments, milestones, timelines, resource allocations, data collection methodology, and evaluation, step or series of steps to be taken, detailed description of the steps used to implement a strategic plan, a plan to determine what information is missing or pending, where and when to collect this information, and who will need the information and anything related to active note(s) which are useful to active note(s) provider(s) and associate one or more accessible metadata or fields.

Associated or attached accessible metadata or fields comprising one or more applications, services, shared workspace(s), active links or URL for communication, collaboration, answering participation, tracking, workflow, associate date & time, matched advertisements, invitation request, resource types, resource structured tag types, location, language, resource sources, categories, taxonomies, controlled vocabulary, keyword(s), ontology, ranks, status.

Sending and response(s) session between or among active note(s) provider(s) and responder(s) comprises one or more determining of responders, drafting or auto generating or identifying, sending and processing active note(s) or sub active note(s), identifying, sending, receiving, selecting, editing or modifying, processing & clarifying concepts, preparing, processing & sending response(s), communications, collaboration, clarification, answers, routing, assigning, workflow, calls, emails, messages, videos, online meetings, searching & matching, sharing, e-commerce, aggregating, tracking, follow-up, actions, events, transactions, activities, participation, attaching active links & resources including applications, services, multimedia contents or resources links with response, applying privacy settings and preferences, selecting, filtering, subscribing, mapping, downloading, accessing, invoking, programming, book marking, attaching, detaching, assigning, federating, integrating, distributing, ranking, commenting, composing, comparing, co-coordinating, orchestrating, choreographing, organizing, recording, configuring or customizing, classifying & grouping, connecting, disconnecting, editing, updating, synchronizing, transacting, binding with 3rd party applications, networks, services & devices via web services & API, forwarding, transferring, merging, joining, listing, linking, arranging, scheduling, automating, sequencing and ordering, sending, receiving, managing, monitoring, registering, accounting & metering, reporting, logging and executing between or among one or more or group or combinations or series or sequences of active note(s) and/or active note(s) provider(s) and/or response(s) and/or responder(s).

The central unit can receiving and processing said one or more concepts and/or response(s) from each of at least a portion of the target responders, wherein said processing comprising receiving, storing, updating, indexing, validating & formatting including editing, clarifying, update details, fonts settings, spell checking, language & spam detecting, translating, transcribing, converting to other formats like voice, text, associating priority types including high, normal, low, expiration, date & time, categories, keywords, locations, advertisements, payment information, profile data, URL, dynamically attaching one or more system data, suggested response(s), active links, informational links, attachments, multimedia contents, applications and service including communication utilities and shared workspace for providing response or multidimensional active resources & actions, collaboration, participation, tracking, answering, communication, workflow, services & task fulfillment, searching, sharing, social networking, purchasing, transactions, information and determining one or more responders for sending or routing or publishing said active note(s) to one or more determined responders and determining one or more receivers or active note(s) provider(s) for sending or routing or publishing or presenting said concepts and/or resource(s) to one or more determined receivers or active note(s) provider(s) based on one or more preferences and privacy settings or searchers based on one or more search criteria.

The system & method can allow active note providers to assign rank, sort, organize, categories, bookmark, filter, select, save, share, edit or update, store, use, process one or more received concepts and/or responses, set active note session status and tracking status including active, pending, completed, executed or used or like, concepts or response received, set active note as public or private or shared types, associate metadata including keywords, categories, provide comments on one or more selected or executed or liked or used responses and submit said one or more selected active note(s) and/or related one or more concepts and/or responses to central unit for storing, editing or updating, indexing, validating, formatting, associating data, processing for making them searchable to other users based on one or more search criteria.

The system & method can allow responders to assign rank, sort & order, organize, categories, bookmark, filter, select, save, share, edit or update, store, process one or more received active note(s), set response session status and tracking status including active, pending, completed, assigned or forwarded, concepts or response sent, set concepts or response as public or private or shared types, associate metadata including keywords, categories, provide comments on one or more selected active note(s) and submit said one or more selected active note(s) and/or related one or more concepts and/or responses to central unit for storing, editing or updating, indexing, validating, formatting, associating data, processing for making them searchable to other users based on one or more search criteria.

Presenting or attaching an advertisement to a user or active note(s) provider(s) with or within active note(s) and/or related concepts and/or response during the sending, receiving, selecting and presenting.

Allowing a responder or an active resources & actions provider(s) to accept an active note(s) to designates the advertisement. Advertisers may bid for position and placement and timing of ads associated with keywords on the responder's or active resources & actions provider's GUI and the responder(s) active resources & actions provider(s) can optionally pick which advertisement is presented.

In one embodiment, a user interface that enables users to post content items in one or more communication channels of the social network also includes an interface that allows the posting user to identify one or more nodes or active links within the posted content item. For example, a trigger received in the interface may indicate that a user wishes to reference a node in the posted content item from list. Selectable links may be provided to enable the user to author a content item comprising a link to another node or active link in the social network. After sharing the content item comprising the link to another node in the social network, another user can access node or active link.

In one embodiment, a social network enables a user to identify, reference, or otherwise mention another node while posting a content item to the social network. “Nodes” on a social graph in a social network may represent objects on the social network, such as actual users and other entities within the social network that have profile information. These types of entities may post content to communication channels within the social network. For example, a user and the user's friends in the social network are included in this category of nodes. These nodes have “identities” because they represent actual users and entities with profile information. Entities such as products or brands, celebrities, and teams, may also have identities because an actual entity is identified and claimed in the social network. Other types of nodes, such as applications, services, actions, transactions, digital content, events, groups, network and objects, may also have “identities” because those nodes may be controlled by a specific user or entity.

In one embodiment, present invention provides managed, organized, secure, interactive, real time, trusted, unified and controlled new next generation super internet network, contextual search engine, multi communication channels, dynamic e-commerce, zero click unobtrusive advertisement and human or social operating system which monitors, tracks, records each activities, actions, transactions, events of each participating users and facilitates each related activities, actions, transactions, events of each user by providing on demand, customize, contextual, dynamic & unified communication. Present invention can also able to predict future based on each entity related each recorded, updated and stored activity, actions, transactions, events and related ranked responses, active links and actions. User can search ranked actions, active links and response for active note(s) from past active note(s), related response, active links & actions.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 illustrates example of graphical user interface (GUI) for the central server search engine;

FIG. 3 illustrates example of graphical user interface (GUI) for the user home for posting active notes and/or providing responses with or without attaching active links;

FIG. 4 illustrates example of extended graphical user interface (GUI) of FIG. 12 for the user home for posting active notes and/or providing responses with or without attaching active links and managing resources;

FIG. 5 is a logical flow diagram generally showing one embodiment of a process for zero click advertisements;

FIG. 6 is a logical flow diagram generally showing one embodiment of a process for dynamic e-commerce.

FIG. 7 illustrates example of graphical user interface (GUI) for the central server search engine.

### DETAILED DESCRIPTION OF THE DRAWINGS

### Illustrative Operating Environment

The above specification, examples, and data provide a complete description of the manufacture and use of the composition of the invention. Since many embodiments of the invention can be made without departing from the spirit and scope of the invention, the invention resides in the claims hereinafter appended

### Website Architecture

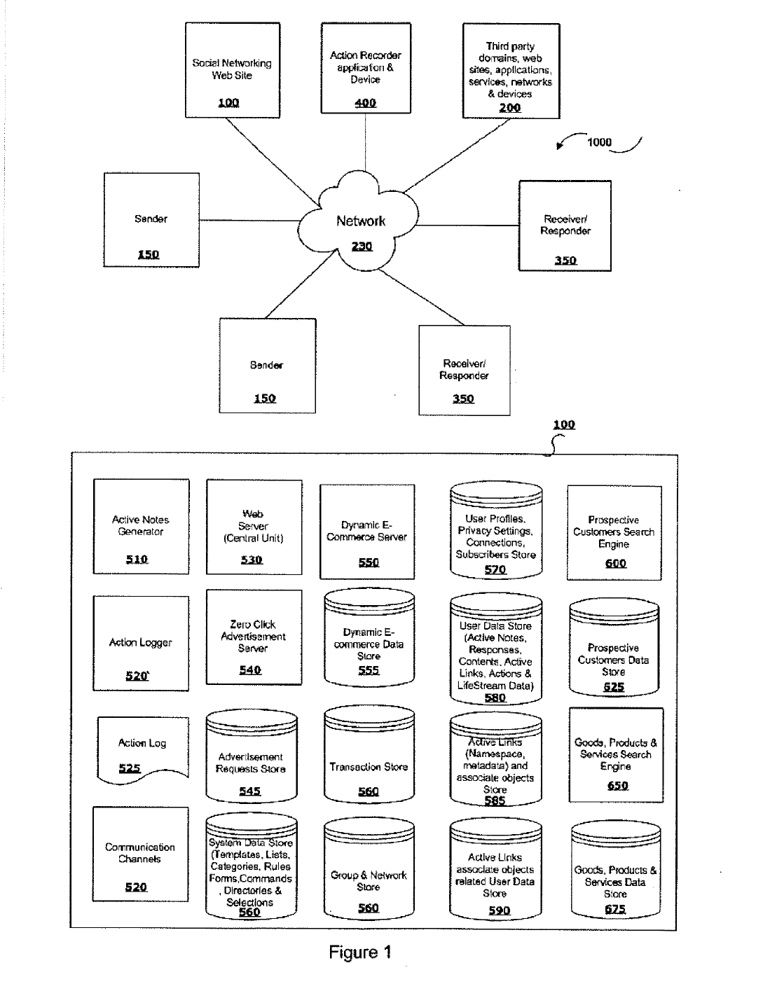

FIG. 1 is a high level block diagram illustrating a system environment suitable for operation of a social networking website 100. The system environment comprises one or more client devices 150 and 350, one or more third-party third party domains, web sites, applications, services, networks & devices 200, a social networking website 100, and a network 230. In alternative configurations, different and/or additional modules can be included in the system.

The client devices 150 and 350 comprise one or more computing devices that can receive member input and can transmit and receive data via the network 230. For example, the client devices 150 and 350 may be desktop computers, laptop computers, smart phones, personal digital assistants (PDAs), or any other device including computing functionality and data communication capabilities. The client devices 150 and 350 are configured to communicate via network 230, which may comprise any combination of local area and/or wide area networks, using both wired and wireless communication systems. As described above, the third party domains, web sites, applications, services, networks & devices 200 and the action recorder-150 are coupled to the network 230 for communicating messages to the social networking website 100 about the members' actions off the website 100.

The social networking website 100 provides customize, contextual, unified and integrated communication to users of network for that social networking website 100 registering each members and receives and stores each users profiles, privacy settings, preferences, connections with other users of network to user profile store 570, allow sender 150 to determine one or more target receivers 350 based on one or more connections, match making, selections, subscriptions stored at user profile & connection store 570, allow sender 150 to dynamically associate one or more identified active links with active note (message) or response of active note (message) based on active links owned, uploaded & registered, controlled by user or matched active links provided by other connected users, advertisers, responders, service providers and social networking website 100 stored at active links and associate accessible objects store 585, allow sender 150 to send or post said active note (message) or response of active note (message) with active link(s) to determined target receivers 350, wherein said active link(s) enables receivers 350 to sell, purchase, transact, communicate, collaborate, workflow, provide response, participate in same activities as sender and access the active link(s) for message specific purpose in an integrated, contextual and unified manner. The social networking website 100 receiving, storing and processing said active note (message) or response of active note (message) at the web server 530 and storing in user data store 580 and presenting said active note (message) or response of active note (message) to determined target receivers 350 as per preferences & privacy settings. The social networking website 100 allow user to take one or more actions on said active note, related response and associate active links and monitor, track, store, filter and records said one or more user actions in user data store 580.

The social networking website 100 also provides dynamic e-commerce server 550 and related e-commerce data store 555 describes in detail in FIG. 15.

The social networking website 100 also provides zero click advertisement server 540 and advertisement request store 545 describes in detail in FIG. 14.

The social networking website 100 also provides Prospective Customers Search Engine 600 and Prospective Customers data store 625 describes in detail in FIG. 11-50.

The social networking website 100 also provides Goods, Products & Services Search Engine 650 and Goods, Products & Services Data Store 675 describes in detail in FIG. 11-50.

The social networking website 100 comprises a computing system that allows members to communicate or otherwise interact with each other and access content as described herein. The social networking website 100 stores member profiles that describe the members of a social network, including biographic, demographic, and other types of descriptive information, such as work experience, educational history, hobbies or preferences, location, and the like. The website 100 further stores data describing one or more relationships between different members. The relationship information may indicate members who have similar or common work experience, group memberships, hobbies, or educational history. Additionally, the social networking website 100 includes member-defined relationships between different members, allowing members to specify their relationships with other members. For example, these member defined relationships allows members to generate relationships with other members that parallel the members' real-life relationships, such as friends, co-workers, partners, and so forth. Members may select from predefined types of relationships, or define their own relationship types as needed.

FIGS. 1-100 is an example block diagram of a social networking website 100. The social networking website 100 includes a web server 530, an action logger 520, an action log 520, an active notes generator 510, an ad server 540, a database of ad requests 545, en e-commerce server 550, e-commerce data store 550, a member profile including privacy settings, preferences & connections store 570, a group & network store 560, an event store, each active link related namespace, properties, metadata & associate objects store 585, each active link associate object or application related user data store 590, a transaction store 560, user data store including active notes, responses, contents, active links, actions & LifeStream data store 580 and system data store including templates, lists, categories, taxonomies, keywords, rules forms, commands, directories & various selections 560. In other embodiments, the social networking website 100 may include additional, fewer, or different modules for various applications.

The web server 530 links the social networking website 100 via the network 230 to one or more client devices 150 and 350, as well as to one or more third party websites 200. The web server 530 may include a mail server or other messaging functionality for receiving and routing messages between the social networking website 100 and the client devices 150 and 350 or third party websites 200. The messages can be instant messages, queued messages (e.g., email), text and SMS messages, or any other suitable messaging technique.

The action logger 520 is capable of receiving communications from the web server 530 about member actions on and/or off the social networking website 100. The received actions can occur within the social networking website 100 as well on other websites, via an application programming interface exposed by the social networking website 100. In one embodiment, the social networking website 100 maintains the action log as a database of entries. When an action is taken on and/or off the social networking website 100, an entry for that action is generated and stored by the action logger 520. Examples of user actions within the social networking website 100 include adding resources & notes to user's LifeStream including adding health report, results, bills, invoices, scanned documents and describe in detail in specification, posting active notes, receiving active note related responses, attaching active links, take one or more actions on each active note, related response and active links including purchase or sell products, book tickets, user likes one or more brands, joining a group, communication & sharing with other users. Examples of user actions outside of the social networking website 100 include purchasing or reviewing a product or service using an online marketplace hosted by a third-party website 140, auto recorded, auto detected, auto sensed, auto selected or extracted from user's life stream, auto extracted from video or audio or images, auto identified, auto determined, auto generated and auto posted one or more active notes (messages) from one or more applications, services, networks and devices based on monitoring, tracking and recording of user actions, events, current location, transactions & activities by action recorder applications & devices 400.

The action logger 520 includes data describing the member performing the action, the date & time the action occurred, an identifier for the member who performed the action, an identifier for the member to whom the action was directed, an identifier for the categories of action performed, an identifier for an object acted on by the action (e.g., an application), content associated with the action, identifying one or more objects associate with actions, dynamically identifying and associating one or more active links & applications or application features with action, who-what-where-when-how-where about the action occurred and/or other data describing the action. The action logger 520 can communicate with the all active links, objects, applications, services, groups, networks, data & content stores of network related to actions and/or user related to action. The action logger 525 can organize the stored action data according to an action identifier which uniquely identifies each stored action.

The active notes generator 510 generates communications for each member about information that may be relevant to the member. These communications may take the form of active notes, each active note is an information message comprising one or a few lines of information about an action in the action log that is relevant to the particular member. The active notes are presented to a member via one or more pages of the social networking website 100, for example in each member's home page or active notes page. An active note is a message that summarizes, condenses, or abstracts one or more member actions from the action log 525. The generated active notes can then be transmitted to one or more related members e.g., the member's connected users, friends, subscribers, and auto matched responders allowing the member's actions to be shared with related members. More about user action describe in U.S. patent application Ser. No. 11/995,343, titled: “A method and system for communication, publishing, grouping, advertising, searching, sharing and dynamically providing a Journal Feed” and divisional U.S. patent application Ser. No. 12/973,370, titled: “A System and method for publishing, communication and real time searching”

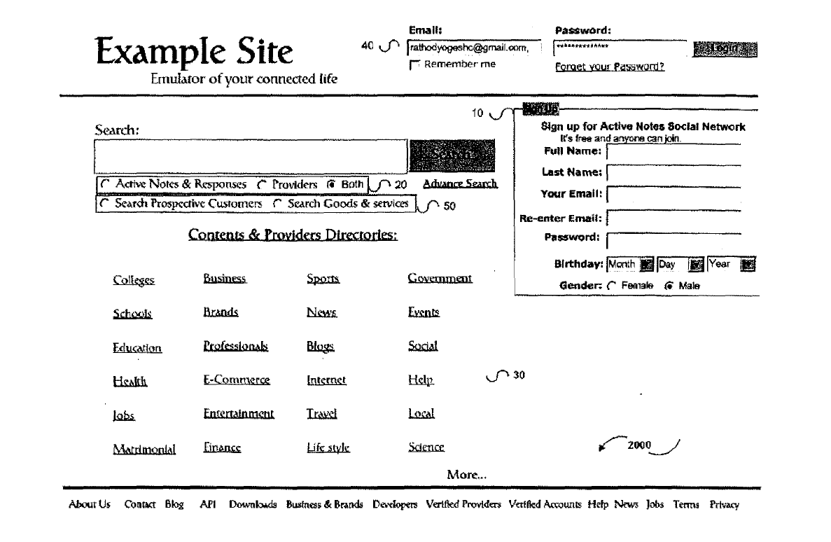

FIG. 2 illustrates an exemplary GUI 2000 for home of example site where guest or unregistered users & registered users without log-in can search public contents 20 or browse directories 30 of ranked public contents including active notes, related responses, associate active links and user actions. User can register by sign-up 10 with the system by entering basic user details including name, user name or email, password, birth date and gender for quick registration. After basic registration user can sign-in 40 with the system by entering username or email and password. Registered users can search 20 & browse directories 30 and subscribe providers or responders. User can register as a general or anonymous user or verified user. User can also create multiple users accounts or linked accounts. User can act as an active note(s) sender user and/or responder user. Responder user can create one or more service profiles for providing service based responses or user can update basic responded details for providing responses to other users.

FIG. 2-50 illustrates an exemplary prospective customer's search engine GUI. Web server 530 of the social networking web site 100 receives, stores 580, indexes, orders, ranks and processes active notes and associate data including metadata, attachments, privacy settings, list of responders, responses, communications, active links and user actions from plurality of users for making them searchable for other users. Web server 530 identifies prospective customers' related active notes from said plurality of active notes based on said active notes and associate data and stores and process said identified prospective customers' related active notes with metadata at Prospective Customers Data Store 625. In one embodiment, searching user enter search query to GUI FIG. 2-50 or search engine 600 for searching prospective customers related active notes and associate data & active links for identifying prospective customers. Prospective Customers Search Engine 600 of web server 530 presents ranked & chronological search results to searching user based on matching search query with said identified prospective customers data for said search query comprising one or more identified active notes & associate data including active links related to one or more prospective customers, wherein said each active link(s) associate with active note enable searching user to provide response, communicate, collaborate, participate, make offer, provide deal, sale product or ecommerce, workflow, make transaction with buyer, negotiate, provide discount, share and provide media data & information to related prospective customer or sender of active note and notify each author or sender of each active note of search results about searching user searches, selects and received said search results related active notes and allow each author or sender of active note to communicate, collaborate, participate, accept offer, receive deal, buy product or ecommerce, make transaction with seller, negotiate with seller, ask or receive discount, share and receive media data & information with selective one or more active note receiver or seller with receivers based on said active note associate active link(s).

FIG. 2-50 illustrates an exemplary prospective goods, products & services engine GUI. Web server 530 of the social networking web site 100 receives, stores 580, indexes, orders, ranks and processes active notes and associate data including metadata, attachments, privacy settings, list of responders, responses, communications, active links and user actions from plurality of users for making them searchable for other users. Web server 530 identifies offering of goods and services related active notes from said plurality of active notes based on said active notes and associate data and stores and process said identified offering of goods and services related active notes with metadata at Goods, Products & Services Data Store 625. In one embodiment, searching user enter search query to GUI FIG. 11-50 or Goods, Products & Services Search Engine 650 for searching offering of goods and services related active notes and associate data & active links for identifying goods and services. Search engine 600 of web server 530 presents ranked & chronological search results to searching user based on matching search query with said identified offering of goods and services data for said search query comprising one or more identified active notes & associate data including active links related to one or more offering of goods and services, wherein said each active link(s) associate with active note enable searching user to communicate, collaborate, participate, accept offer, receive deal, buy product or ecommerce, make transaction with seller, negotiate with seller, ask or receive discount, share and receive media data & information from publisher of active note or seller of goods & services and notify each author or sender of each active note of search results about searching user searches, selects and received said search results related active notes and allow each author or sender of active note to provide response, communicate, collaborate, participate, make offer, provide deal, sale product or ecommerce, workflow, make transaction with buyer, negotiate, provide discount, share and provide media data & information to selected one or more active note receiver or buyer of goods & services based on said active note associate active link(s).

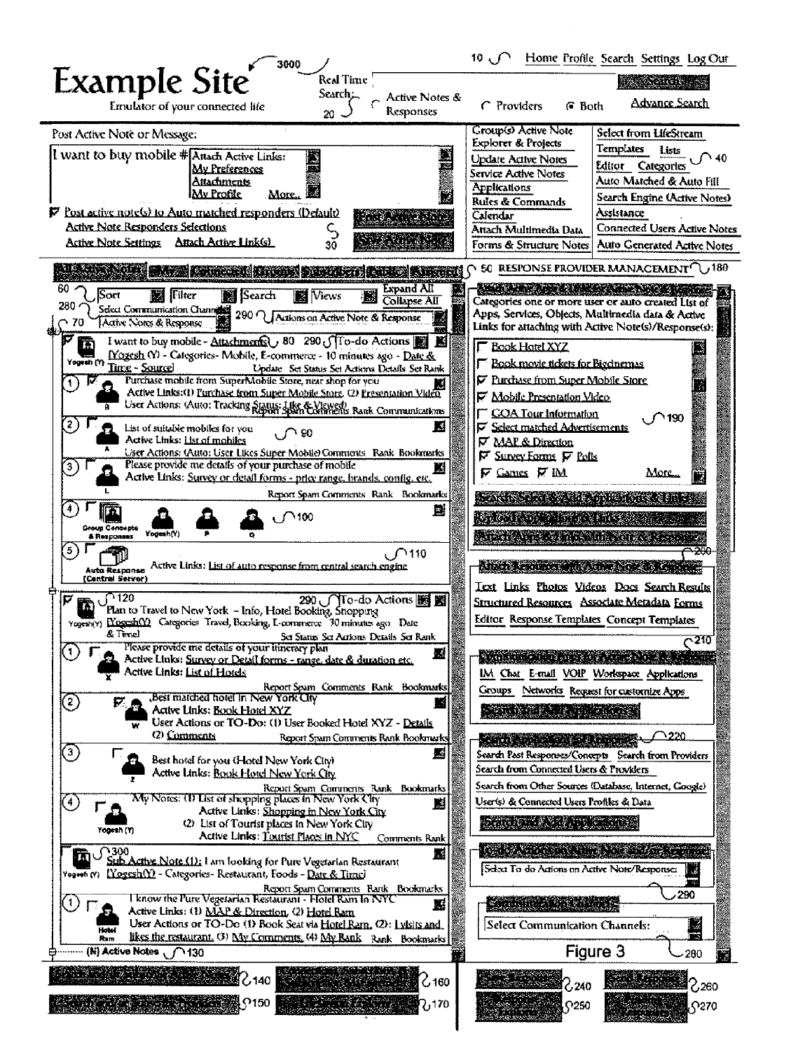

FIG. 3 illustrates an exemplary GUI 3000 for User home & profile where system provides User Settings 10 for editing and updating user Account(s), update or edit user profile(s) including user details and responders details, one or more service profile(s), privacy settings & preferences, 3^{rd} parties applications & services related privacy settings, change password, notification setting including notify user when some events triggers, mobile settings for enabling system over mobile & other smart device, language selection, provide or update payment information, preferences for auto match making and dynamically creating group(s), update user connections or contacts via suggested users list, finding people from present network or other sources, searching & matching and/or subscribing users or responders, invite other users or accept invitation from other users, browse directories for searching categories users or responders, subscribe one or more users or responders or service providers, join one or more networks & groups. User can create & update one or more categories lists and groups and attach or detach one or more connections to each list or group. User can also manage categories list of Subscribers & Subscriptions for sending active notes & messages and providing responses. User can search, add or install, delete one or more applications, services and communication channels with profile or user home.

Central unit FIG. 1-530 maintaining for each of plurality of users of network(s), a user account(s) including verified account and anonymous or general account, one or more public, private & shared user profile(s) for active note providers and/or responders, service profiles of service provider responders, preferences & privacy settings for connected users, communication channels, applications, contents, profiles, activities and actions and maintaining set of user connections with other users of the network(s) and allowing users or active note(s) provider(s) and responders to creating and updating connections list(s) based on contacts, invitations, finding people from internal or external networks, searching & matching, subscribing, bookmarking and match making based on privacy settings & preferences.

Central unit FIG. 1-530 also maintaining applications, services, communication channels, list of applications, services, communication channels of 3^{rd} parties and associate system & user data, list of categories networks & groups and associate users, users connections & users data and maintaining active links, applications or application features links, shared workspace links for attaching with active note by active note sender or with response by responder, contents including any types of multimedia data, transactions, messages, updated user status actions and events.

FIG. 3 illustrates an exemplary GUI 3000 for User home & profile where user can mange active notes and related all response & communications 30 & 50 as well as manage providing responses and related all communications 180. Active Notes Management including Active Note Posting Management 30 where user can draft & manually post or auto post or conditional post Active Note(s) related to Active Notes & Responses Communication Channel or post messages related to one or more other communication channels.

User can draft active note(s) or select one or more other options 40 for sending Active Note(s) including managing and posting plurality of categories group(s) of Active Note(s) by multiple users via project or explorer management, update posted Active Note(s), Search & select from past Active Note(s), Services related ready Active Note(s) or templates, Active Note(s) related applications like travel, finance, marketing, e-commerce, health, Select one or more Active Note(s) integrated & interpreted rules, conditions, commands and part of Active Note(s), use calendar for selecting & updating drafted Active Note(s), select one or more multimedia data as Active Note(s) including video, image, file, docs, link or URL and text, draft or select Active Note(s) from subject specific categories forms or structured Active Note(s) for surveying user including user can select one or more products or brands from list to sell or purchase or refer or publish, select one or more Active Note(s) from one or more categories updated lists including list of brands used by user, list of brands like by user and other updated lists, select Active Note(s) from user's Life stream, select Active Note(s) from categories templates, use full features editor for drafting Active Note(s), search & select Active Note(s) based on one or more search criteria, auto match Active Note(s) based on one or more keywords, categories, selections, profile, past active notes, responses, life stream data, user behavior, relevancy & preferences, use expert assistance from user connected users and subject or domain specific responders fro drafting and preparing Active Note(s), search & match user connected users Active Note(s). System can also auto generate one or more Active Note(s) based on monitoring, storing or recording user's filtered or selected activities, actions, events and transactions and dynamically attaching one or more active links & apps and posting said auto generated Active Note(s) to user connected users or subscribers or matched users, wherein active links & apps enabling receiving users or responders to participate, communicate, collaborate, sell or ecommerce with Active Note(s) provider users.

User can apply or set various settings with all (default settings) or to each posted Active Note(s) including associate one or more categories, keywords, metadata, attachments of multimedia data including links, images, video, files, apply security & privacy settings including public, private & shared and selections of Active Note(s) receivers or responders, select type or categories of Active Note(s) including share, communication, e-commerce, search, task and communication channel type or name, Set conditions, rules, schedule Active Note(s) posting or Auto Post of Active Note(s) settings based on calendar, events, date & time range, make Active Note(s) as Group Notes based on invitation, provide details, categories survey forms based details, set auto generated notes related settings, other settings related to show active note related response to other providers for better & relevant contextual response, select communication channels or apps for posting active note or messages, select preferred communication channels or apps or device for receiving response(s).

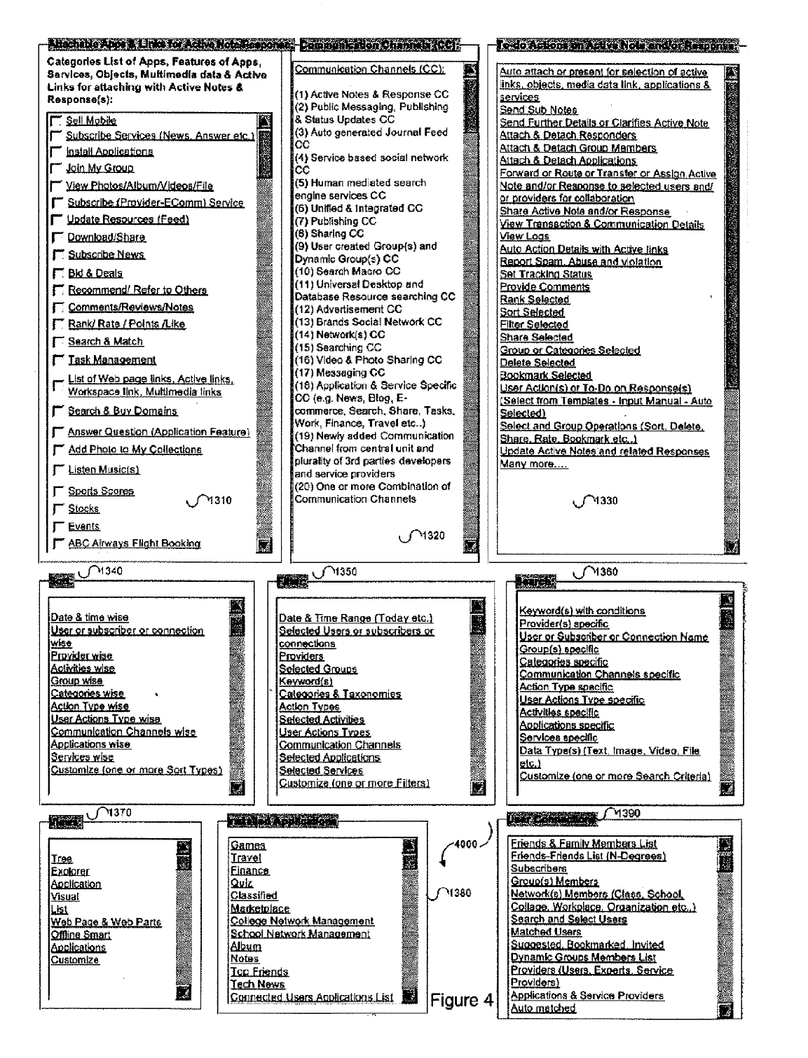

User can attach one or more active links, objects, applications, services & application features with Active Note(s) from FIG. 3 (190) & FIG. 4 (1310) for participating, communicating, collaborating, transacting with responders based on user selection or selection from system provided matched list of active links and active applications or services or application features or auto attaching one or more active links and/or active applications or services or application features based on Active Note(s) text analysis, past Active Notes, user profile & user data. A “trigger,” such as a special character or symbol, may be used while inputting text to indicate that the user desires to identify active links. Selectable active links are then provided to the user responsive to the trigger. These selectable links may also be called candidate active links because they comprise the active links which the user may wish to reference. In one embodiment, the provided active links are narrowed responsive to additional input from the user. Thus, a user may quickly and easily reference one or more active links while posting an active note to the social network.

Selectable links enable the user to mention one or more active links in the social network when posting an active note as describe in U.S. patent application Ser. No., titled: “A System and Method for generating and updating information of connections between and among nodes of social network”. List FIG. 3 (190) & FIG. 4 (1310) comprises plurality of attachable and accessible objects of network that host and link by central unit FIG. 10-530 or from external network & domain, developer of application, develop by user, service providers including one or more profiles of user and connected users, identity of user and resources, contents, publications, media data & items including image, photo, video, audio, message, communications, lists, attachments, applications, services, groups, networks, links or URLs, AI Agents, pages, search results, brands name or objects name, advertisements, logs, search macros, auto generated messages, relationships, one or more or list of user connections objects, subscribers, privacy settings, structured data like list of brands, domain specific categories survey forms for getting more details in structured way and any other objects.

For example FIG. 4 (1310) user can select & attach “Sell Mobile” active links & apps from list of active links & apps with message “I want to Sell Mobile” and send to matched or connected or subscriber or responder users of network, wherein said links enable said users to buy mobile by clicking and using said active links or applications and system tracks the user action on said Active Note(s) and related response.

Another example is that user send message “I want to buy mobile—Attachments” and send to matched or connected or subscriber or responder users of network and related one or more responders can attach one or more active links and apps with said response like responder send response “Purchase mobile from SuperMobile Store, near shop for you” and attach active links or applications or application features or services like Links: (1) Purchase from SuperMobile Store, (2) Mobile Presentation Video and send said response to said Active Note(s) provider, wherein said links enable said users to buy mobile by clicking and using said active links or applications and system automatically tracks user's actions on said response like “User Actions: (Auto: Tracking Status: Like & Viewed)” and related active links or apps or stores user defined action and comments like “Purchase from SuperMobile Store at Mulund”. Central unit FIG. 10-530 receives, stores, indexes and process said Active note(s), related responses & active links & applications and associate system generated or user defined one or more user actions on said Active note(s), related responses & active links & applications and making them searchable for other users based on ranking and one or more search criteria.

User can determine and select one or more responders based on auto match making, search, match, filter & select from categories list(s) of user connections including friends, friends of friends, family, co-workers, classmates, Search, invite & select users from central search engine and other sources or external domains, select from one or more categories list of subscribers, search, subscribe & select one or more verified providers or responders from categories lists, online available matched public providers, select based on one & two way match making preferences, select from bookmarks of responders or users, select from suggested responders or users or service providers, select responders based on dynamically created Group based on online available matched users, similar activities, location, applications, interest, categories, select service based responders based on service profile, select one or more user networks, groups, customize selection of responders including selection conditions, rules, search specific name, connections, networks, groups, interest, activities, location. User can select or update responders for all Active Note(s) (default) or for each Active Note(s). User can save or post one or more Active Note(s).

User can manage all Active Note(s), related Response(s) and communications from all responders, sources & communication channels (All Active Notes Tab) 50 including user's own all Active Note(s), related Response(s) & communication (My Active Notes Tab) where user can receive responses from and communicate with plurality of related responders and communication channels.

User can select or switch one or more or combination of communication channels 280 (more detail in FIG. 4—1320) and set default communication channel e.g. 280 shows default “Active Notes & Response” communication channel.

User can 60 select various types of Sort (more detail in FIG. 4—1340), Filter (more detail in FIG. 4—1350) & Search (more detail in FIG. 4—1360) options for Active Note(s), related Response(s) & communication data and select view type (more detail in FIG. 4—1370) for presenting and managing Active Note(s), related Response(s) & communication.

FIG. 4 illustrates an exemplary GUI 1340 for presenting to user various Sort 60 options or selections for sorting of Active Note(s), related Response(s) & communication data and source of responses including User or subscriber or connection wise, Date & time wise, Provider wise, Activities wise, Group wise, Categories wise, Action Type wise, User Actions Type wise, Communication Channels wise, Applications wise, Services wise, Customize Sorting and any combination thereof.

FIG. 4 illustrates an exemplary GUI 1350 for presenting to user various Filter 60 options or selections for filtering Active Note(s), related Response(s) & communication data including Date & Time Range, Selected one or more Users, subscribers, connections, Providers, Groups, Networks, Keyword(s), Categories & Taxonomies, Ranking & Rating, Active links & apps types, Activities, User Actions Types, Communication Channels, Applications, Services, Resource or media data types including image, video, audio, text, docs, file, status types and any combination thereof.

FIG. 4 illustrates an exemplary GUI 1360 for presenting to user various Search 60 options or selections for searching Active Note(s), related Response(s) & communication data including searching based on One or more Keyword(s) with conditions, Provider(s), Users, Subscribers, Connections Name, Group(s) specific, Categories specific, Communication Channels specific, Action Type specific User Actions Type specific, Activities specific, Applications specific, Services specific, Media Data Type(s) including Text, Image, Video, File and any combination thereof or customize one or more search criteria.

FIG. 4 illustrates an exemplary GUI 1370 for presenting to user various Views 60 options or selections for selecting presentation and management type for managing Active Note(s), related Response(s) & communication data including Tree-Branch style 70, Explorer style, Application style, Visual style, List style, Web Page & Web Parts, Offline Smart Applications and Customize.

FIG. 4 illustrates an exemplary GUI 1320 for User to select one or more communication channels 280 for presenting and managing all messages or communication data related to said selected one or more communication channels including:
(1) Active Notes & Response Communication Channel (280) as describe in this invention.
   Examples:
      (1) Example 1—Step 1: Active Note sends by sender User [Y]=“I want to buy mobile” FIGS. 3—80 with Attached Active Link(s): (1) Specification Attachments and associate metadata including source, categories, keywords, data & time. User interface presenting to user each Active Note send by user. For example Tree style user interface 70 presents each active note 80, 120, 300 & 130, accessible metadata and responses for each active note to user. User interface also provides various operations on selective Active Note(s) & Response(s) 290 Actions & To-Do, Tracking & Logging User Actions, updating user interface based on receiving, sending, updating, user actions, transactions, events, user activities, auto actions, actions by other users.
         Step 2: Matched target Receivers or Responder Users [A, B, C, D, L, P, Q and Central Server] receives said Active Note via central unit FIG. 1-530, in which User [Y] receives said Active Note 80 related responses from FIG. 3—80 (Responses—1 to 5) Users [B, A, L], Group Response from Users [User's Own Response, P, Q] and Auto Response from [Central Server]. For example FIG. 3—80 (Responses—2) User [B] provides response “Purchase mobile from Super Mobile Store, near shop for you” and attaching Active Application & Service Link(s): (1) Purchase from Super Mobile Store application & service and Active Media Content (2) Mobile Presentation Video with said response for said Active Note received from User[Y].
         Step 3: Active Note provider [Y] receives said all responses with attached one or more active links and applications from said responders for said Active Note 80. For example User [Y] can ask further details or clarify the offer or communicate with responder user [B] by using one or more unified communication applications. User [Y] clicks on Purchase from Super Mobile Store application & service link and system opens Purchase from Super Mobile Store application in an integrated environment or on web page, so user can easily view information, enter buying details, make payment and purchase said mobile. Active Note Receiver or Responder User [B] give rating to said Active Note & Active Note provider based on frequent purchaser, fast purchasing of product and other criteria and User [Y] can also provides rating and comments on Responder User [B] and on said transaction or response based on reasonable price, good communication & service, fast product delivery, relationships, frequent purchase and other criteria.
         Step 4: Central unit FIG. 1-530 monitors, records or logs or tracks, stores, indexes, filters & process user's said one or more actions, activities, To-Do, events, transactions, rating, comments & communications including who, what, where, when, how about action on said active Note and identify related objects links like User [B], ABC, User [Y], Purchase from Super Mobile Store indicating source(s) of action, Active Note source, Responder or Action doer, source of Action on Active links & application and auto generates and present said one or more user actions on each response of each Active Note. For example: system presents tracking status to receiver of active Note User [B]—Tracking Status: User [B] sell mobile ABC to User [Y] by using Purchase from Super Mobile Store and receives payment of Rs. 5500 (Date & Time) and system presents tracking status to provider of active Note User [Y]—Tracking Status: User [Y] buys mobile ABC from User [B] by using Purchase from Super Mobile Store and make payment of Rs. 5500 (Date & Time)
         Step 5: Sender of Active Note [Y] as well as Responder User [B] can manually provides User Actions on each response of each Active Note. For example User [B] provides User Action manually or selecting from ready templates: “I buy mobile ABC” and User [Y] gives User Action: “I sell 20^{th} mobile ABC at the rate of Rs. 5500 within 1 hour”
         Step 6: Central unit FIG. 1-530 receives, stores, indexes and processes each Active Note & attached active links & applications, each Active Note related each response & attached active links & applications, each Active Note and/or Response related system and user defined Actions, Rating or Ranking and comments and making all said resources searchable for other users based on one or more search criteria.
         So purpose specific Active Note and associate active links & applications for clarifying, solving said Active Note related purpose i.e. [I want to Buy Mobile] created by Active Note Provider or sender of message, Matched target revivers or responders receives said Active Note, one or more revivers or responders among said target revivers or responders can provide response with attaching matched active links & application for solving said Active Note related purpose i.e. [I want to Buy Mobile]. Active Note Provider receives said response and said integrated active links or applications enables Active Note Provider to [Purchase Mobile] and transaction or purpose of Active Note is completed and solved.
         All steps are not compulsory and fewer steps can take place, concurrent one or more steps in any order can take place and any sequence and combinations are possible.
      (2) Example 2—Step 1: Active Note sends by sender User [Y]=“Plan to Travel to New York—Info, Hotel Booking, Shopping” FIG. 3—120 and associate accessible metadata including user profile, source (web site or mobile or external domain), categories & keywords (Travel, Booking, E-commerce), data & time.
         Step 2: Matched target Receivers or Responder Users [X, W, Z, P, Q] receives said Active Note via central unit FIG. 1-530, in which User [Y] receives said Active Note 120 related responses from FIG. 3—120 (Responses—1 to 4) Users [(1) X, (2) W, (3) Z] and User's Own Response (4). For example (1) User [X] response is “Please provide me details of your itinerary plan” and attaches Active Links: (1) Survey or Detail Forms (for price range, date & duration, likes) and (2) Active Links: List of Hotels for getting further details, communication, choice and clarifying various related things. User [Y] provide details in said survey forms and select some possible hotels from list and send said survey form(s) with selection to responder User [X]. Responder User [X] further transfer and assign said user active note with details to other matched responder users [W] and [Z] for receiving response for User [Y]. (2) Responder User [W] provides response “Best matched hotel in New York City” and attach Active Links: Book Hotel XYZ and (3) Responder User [Z] provides response “Best hotel for you (Hotel New York City)” and attach Active Links: Book Hotel New York City. User [Y] gets said response from User [W] and User [Z] directly or via User [X] after verification, editing & updating said responses by User [X]. User can also provide own response with own said active note. User [Y] provides response “My Notes: “(1) List of shopping places in New York City” and Active Links: Shopping in New York City and “(2) List of Tourist places in New York City” and attach Active Links: Tourist Places in NYC.
         Step 3: User [Y] likes response of responder User [W] and clicks on Book Hotel XYZ application & service link and system opens Book Hotel XYZ application in an integrated environment or on web page, so user [Y] can easily view information, enter booking details, make payment and book hotel XYZ. Active Note Receiver or Responder User [W] give rating to said Active Note & Active Note provider [Y] based on frequent booking customer, speed booking and other criteria and User [Y] can also provides rating and comments on Responder User [W] and on said transaction or response based on reasonable room rates, good communication & service, fast booking, relationships, frequent bookings and other criteria.
         Step 4: Central unit FIG. 1-530 monitors, records or logs or tracks, stores, indexes, filters & process user's said one or more actions, activities, To-Do, events, transactions, rating, comments & communications including who, what, where, when, how about action on said active Note and identify related objects links like User [w], Book Hotel XYZ, User [Y], Hotel XYZ indicating source(s) of action, Active Note source, Responder or Action doer, source of Action on Active links & application and auto generates and present said one or more user actions on each response of each Active Note. For example: system presents tracking status to receiver of active Note User [W]—Tracking Status: User [W] booked hotel room for User [Y] by using Book Hotel XYZ and receives payment of Rs. 15000 (Date & Time) and system presents tracking status to provider of active Note User [Y]—Tracking Status: User [Y] book hotel room ABC from User [B] by using Book Hotel XYZ and make payment of Rs. 15000 (Date & Time)
         Step 5: Sender of Active Note [Y] as well as Responder User [W] can manually provides User Actions on each response of each Active Note. For example User [W] provides User Action manually or selecting from ready templates: “I book hotel for Use [Y] and give discount 5%” and User [Y] gives User Action: “I book hotel XYZ room”
         Step 6: Central unit FIG. 1-530 receives, stores, indexes and processes each Active Note & attached active links & applications, each Active Note related each response & attached active links & applications, each Active Note and/or Response related system and user defined Actions, Rating or Ranking and comments and making all said resources searchable for other users based on one or more search criteria.
         So purpose specific Active Note and associate active links & applications for clarifying, solving said Active Note related one or more purposes i.e. [Hotel Booking] created by Active Note Provider or sender of message, Matched target revivers or responders receives said Active Note, one or more revivers or responders among said target revivers or responders can provide response with attaching matched active links & application for solving said Active Note related purpose i.e. [I want to Buy Mobile]. Active Note Provider receives said response and said integrated active links or applications enables Active Note Provider to [Purchase Mobile] and transaction or purpose of Active Note is completed and solved.
         Step 7: User can also send one or more Sub-Active Notes related to parent active note. For example User sends 300 Sub Active Note (1): “I am looking for Pure Vegetarian Restaurant” for parent Active Note 120 and associate metadata including source, categories, keywords, data & time. User [Y] sends Sub-Active Note 300 to connected Responder Users [Hotel Ram and Q], in which User [Hotel Ram] send response “I know the Pure Vegetarian Restaurant in New York City” and attach Active Links: MAP & Direction and User [Y] likes and select said response and visit said restaurant and provide various user actions including manual User Actions or TO-Do (1): I visits and likes the restaurant (2): My Comments (3) My Rank. Further steps 4 to 6 take place for said Active Note and related Response & Response Provider.
         All steps are not compulsory and fewer steps can take place, concurrent one or more steps in any order can take place and any sequence and combinations are possible.
      (3) Example 3—Step 1: Active Note sends by sender User [A]=“I want to sell my mobile” with Attached Active Link(s): (1) Specification & Photo Attachments, (2) Sell Mobile and associate metadata including source, categories, keywords, data & time
         Step 2: Matched target Receiver or Responder User [B] receives said Active Note via central unit FIG. 10-530 and can buy mobile by clicking on Active Link: Sell Mobile application & service. System opens Sell Mobile application in an integrated environment or on web page, so user can easily view information, enter buying details, make payment and purchase mobile.
         Step 3: Receiver or Responder User [B] can ask further details or clarify the offer or communicate with sender user [A] and make payment and buys the mobile by using Sell Mobile active link or application & service. Receiver or Responder User [B] give rating to said Active Note & Active Note provider and User [A] provides rating and comments on Receiver or Responder User [B] and said transaction or response.
         Step 4: Central unit FIG. 1-530 or system monitors, records or logs or tracks, stores, indexes, filters & process user's said one or more actions, activities, To-Do, events, transactions, rating, comments & communications including who, what, where, when, how about action on said active Note and identify related objects links like User [B], ABC, User [A], Sell Mobile indicating source(s) of action, Active Note source, Responder or Action doer, source of Action on Active links & application and auto generates and present said one or more user actions on each response of each Active Note. For example system presents tracking status to receiver of active Note User [B]—Tracking Status: User [B] buys mobile ABC from User [A] by using Sell Mobile and make payment of Rs. 5500 (Date & Time) and system presents tracking status to sender of Active Note User [A]—Tracking status: User [A] sells mobile ABC to User [B] by using Sell Mobile and receives payment of Rs. 5500 (Date & Time)
         Step 5: Sender as well as Receiver User can manually provides User Actions on each response of each Active Note. For example User [B] provides User Action manually or selecting from ready templates: “I buy mobile ABC” and User [A] gives User Action: “I sell 20^{th} mobile ABC at the rate of Rs. 5500 within 1 hour”
         Step 6: Central unit FIG. 1-530 or system receives, stores, indexes and processes each Active Note & attached active links & applications, each Active Note related each response & attached active links & applications, each Active Note and/or Response related system and user defined Actions, Rating or Ranking and comments and making all said resources searchable for other users based on one or more search criteria.
         So purpose specific Active Note and associate active links & applications for clarifying, solving said Active Note related purpose i.e. [Sell Mobile] created by Active Note Provider or sender of message, Matched target revivers or responders receives said Active Note, one or more revivers or responders among said target revivers or responders can [Buy Mobile] by using attached one or more active links and integrated applications i.e. [Sell Mobile] and transaction completed.
         All steps are not compulsory and fewer steps can take place, concurrent one or more steps in any order can take place and any sequence and combinations are possible.
      (4) Example 4—Active Note=“My plan is to get admission for ICWA” and auto matched Active Note Responder can provide response with attached Active Link: Admission Forms
      (5) Example 5—Active Note=“Where to purchase cycle?” and selected Active Note Responders can provide response with attached Active Links: MAP & Directions, Purchase Cycle, Presentation & Information Resources
      (6) Example 6—Active Note=“Book tickets of movie “ABC” at Mulund” and auto matched Active Note Responder can provide response with attached Active Link Book Tickets and links enable the Active Note Provider to book movie tickets
      (7) Example 7—Active Note=“I want to rent my house” & attach Active communication application: Instant Messaging (IM) and central server auto matches the customers, wherein link enables interested customers to communicate with said Active Note Provider for further details and clarification. Active Note Provider can refer or forward the said Active Note(s) to other matched or connected users.
      (8) Example 8—Active Note=“Provide me patent related news sources & subscriptions or updates or search results” and attach attachments: List of Keywords and auto matched Patent News related Active Note Responder can provide response with attached list of news subscription sources and Active Note Provider can subscribe said one or more sources and receive updated news from subscribed news sources.
      (9) Example 9—Active Note=“Currently I m in New York City” and plurality of matched responders provides multidimensional concepts and/or responses including shopping, e-commerce, map & direction of shops, exhibition, tourist places, bookings, cabs, tour guides, restaurants, events, discounts and Active Note Provider can select interested response and further communicate with related responders.
      (10) Example 10—Active Note=“My current school project require resources and images related to all tourist places of India” and plurality of matched responders provides multidimensional concepts and/or responses including collections of images and related resources.
      (11) Example 11—Active Note=“I want to discuss on today's cricket match' and attach Active link or application: Discussion Group and connected or matched users can discuss by using said active link or application Discussion Group on said topic i.e. “today's cricket match particular event”
      (12) Example 12—Active Note=“Can you participate with my this game” and attach game application: Game WWW and connected or matched like minded user can participate and play with said game by clicking on game application: Game WWW
      (13) Example 13—Active Note=“Join our School “XYZ” Network and Connected users or student of said school network can join the said network by clicking said active link.
      (14) Example 14—Active Note=“Today I m free pls give some work related to Wikipedia project” and matched responder provides Active links for utilizing said user and knowledge & resources of said user for creating Wikipedia topic specific details or wiki pages.
      (15) Example 15—Active Note=“I like fashion shows” and matched fashion related service providers can receives the said Active Note and provides fashion related paid, free & sponsored services including Videos, experts, marketing of products, consulting, education & training and like.
      (16) Example 16—Active Note=“<List of Brands> provided by Active Note Provider [A]. For example user inputs or selects used and like brands: Brands [A], [B], [C], [D] and [E] and each time when user updates said brand lists, central unit FIG. 10-530 FIG. 10-530 send said list of brands and brand related data to matched customers, brand users, brand owner or sellers, connected users and like for providing resources or responses and/or concepts related to said brands to Active Note Provider [A].
      (17) Example 17—Active Note=“I m currently in Los Angeles” and user can creates group or system dynamically creates group based on location, event, activities, interest, date & time and one or more users can join the group and invite other connected or matched users to join the group with permission. Group members or group users can submit one or more active notes and/or provide responses and communicate, collaborate, and share with each other by using one or more applications, services, networks and devices.
      (18) Example 18—Active Note=“I m looking for any job in NYC” Active Links: (1) Model Profile, Commands: (1) Publish in Public, (2) Advertise Me and Conditions: (1) Instruction: Provide Multidimensional Concepts (2) Response Condition=“Please provide only NYC related jobs information” (Purpose is to collect all available Job in NYC for other job seekers) and all matched responders and users can receive said Active Notes and provide one or more concepts including types of job and sender of Active Note can select one or more interested types of job and receive responses including available job in said selected categories or type in NYC.
      (19) Example 19—User [A] initiate new communication related to “Give Donation to Wikipedia” and Attach Active Link: Donate, application enable other users to give donation and attach one or more connected users or invite other users and other users can accept invitation and join the communication. Other users can also send request to join the said communication and user can accept the request and allow other user to join the said communication. System presents said communication to each member of said communication and enables members of said communication to post one or more active notes and/or provide responses to said one or more active notes.
      (20) Example 20—User [Y] of register with current social network web site [Kootol.com] and other external [Kootol2.Com] integrating services of [Kootol.com] with them by using API, button, plug-ins of [Kootol.com], which enables users to send and receive Active Notes and/or responses from external domains, applications, devices, services, networks and web sites e.g. [Kootol2.Com].
      (21) Example 21—System monitors one or more user's activities & actions and stores user's activities in database e.g. “purchase particular brand(s)”, “refer particular brand(s) to other connected users”. System auto generates one or more active notes each time when user purchase one or more brands or activities occurs and user or system can attach one or more active links with said active notes, wherein said active links enables receiver of said active notes to purchase said brands & communicate with user and send said auto generated and user updated one or more active notes to determined one or more targeted or connected or matched users.
      (22) Example 22—Enterprise user [YYY] can creates one or more projects in multi users & members environment including creates one or more categories or taxonomy classifications in said project and assign rights to one or more users for managing each categories, wherein said assigned users of said each categories can send and receive one or more active notes and/or responses and search, select, register and upload active links related applications, objects, links, pages, services, media contents, take one or more actions on said one or more active notes and/or responses, manage all transactions and communications and like.
      (23) Example 23 (Prospective Customer Search Engine)—Step 1: E.g. Users [A], [B], [C] and [D] post active note regarding “book hotel in NYC” with Active Links: (1) E-commerce App, (2) IM, (3) Map & Directions, (4) Share with Me and associate active note related details & metadata. Central unit FIG. 10-530 receives, stores, indexes and processes said active notes and associate data including metadata, active links and list of target responders or receivers from plurality of users.
         Step-2: Central unit FIG. 1-530 identifies matched prospective customers and related active notes based on said active notes and associate data including categories, keywords, location, metadata, user profile, user data, type of active note like purchase, buy, booking, transact and human mediated identifying prospective customers based on said active notes and associate data.
         Step-3: E.g. Registered User [Hotel Ram] want to search in real time prospective customers related to them. User can submit search query to search prospective customers and each prospective customer associate active note or set one or more search queries and preferences to receive automatically prospective customers and each prospective customer associate active note in real time. E.g. User [Hotel Ram submit search query “Hotel booking and NYC or New York City”
         Step-4: Central unit FIG. 1-530 search & match search results for said search query and present search results or list of one or more prospective customers and associate active notes, each said active note identify prospective customer associate with one or more active links, wherein said active link(s) enable searching user e.g. User [Hotel Ram] to provide response, communicate, collaborate, participate, make offer, provide deal, sale product or ecommerce, workflow, make transaction with buyer, negotiate, provide discount, share and provide media data & information with selective one or more prospective customers. E.g. Central unit FIG. 1-530 list active notes posted by Users [A], [B], [C] and [D] with associate active links, attached data & metadata based on “book hotel in NYC” keyword(s) in active notes posted by said users and order the list based on date & time and rank, wherein said each active note associate one or more active links enable the User [Hotel Ram] to provide response, communicate, collaborate, participate, make offer, provide deal, sale product or ecommerce, workflow, make transaction with buyer, negotiate, provide discount, share and provide media data & information to related prospective customer or sender of active note.
         Step-5: Central unit FIG. 10-530 notifies each sender of active note e.g. Users [A], [B], [C] and [D] about receiving of said active note by receivers or search & selected by searching user e.g. User [Hotel Ram] and allow sender of active note e.g. Users [A], [B], [C] and [D] to communicate, collaborate, participate, accept offer, receive deal, buy product or ecommerce, make transaction with seller, negotiate with seller, ask or receive discount, share and receive media data & information with selective one or more active note receiver or seller with receivers based on said active note associate active link(s). E.g. User [A] communicates with User [Hotel Ram and book the hotel by using said active link associate applications & services.
      (24) Example 24 (Zero click Advertisement)—Step 1: Central unit FIG. 1-530 receives and stores one or more advertisement contents from advertisers. E.g. registered user and advertiser “Hotel Ram” post advertisement contents:
         Advertisement Details=Best Pure Vegetarian Restaurant in NYC
         Keyword(s)=“Pure Vegetarian Restaurant”
         Location(s)=NYC, New York City
         Categories=Restaurant, Foods
         Accessible Active Link(s)=MAP & Direction
         Accessible Responder List with registered & verified Active Link(s)=Hotel Ram (said link enable user to contact Hotel Ram for getting information, booking seat and communication with staff)
         Brand or Identity Name and/or accessible Page or URL=Hotel Ram
         Daily budget=$500 (Daily advertisement amount not exceed to said budget)
         Bid amount for Pay-Per-Keyword occurs in message, associate response(s) & communication for priorities of informing prospective customers=$1.0 per message of per user
         Pay-Per Click based on number of responders receives message, number of responders provide responses, user clicks on active link, advertisement, and take user actions)=$0.1 per click of per user
         Pay Per Transaction (when actual sales or transaction take place)=20% per successful transaction
         Step 2: E.g. User [Y] post active note or message=“I am looking for Pure Vegetarian Restaurant” and associate Categories=Restaurant, Foods and send to responders based on option auto matched responders by central unit FIG. 1-530;
         Step 3: Central unit FIG. 1-530 receives, stores & process said active note or message, wherein processing comprising comparing part of message or each keyword of message and message associate metadata, sender user data & profile, other responses data with each advertisement related keyword(s), targeting criteria and contents and charge advertiser if match making take place. E.g. User [Y] mentioned in said active note or message “Pure Vegetarian Restaurant” keyword with associate Categories=Restaurant, Foods and user current location or system knows from user data that user is now in New York City and system matches said active note content and user data with each advertisement content including said matched advertisement content of “Hotel Ram” which includes matched Keyword(s)=“Pure Vegetarian Restaurant”, Location(s)=NYC, New York City and Categories=Restaurant, Foods and based on said matching of keywords with advertisement content, system charging the advertiser for said advertisement as per pay per keyword(s) occurs in message advertising model;
         Step 4: Central unit FIG. 1-530 send and present said active note or message to matched responders based on various criteria as describe in specification e.g. Central unit FIG. 1-530 sends said active note or message to connected users of User[Y], matched users that visits or know about such type of restaurants and matched said advertisements related or associate responders or verified service providers for providing response e.g. matched said advertisement related responder User [Hotel Ram] receives said active note or message from prospective customer User [Y];
         Step 5: Central unit FIG. 1-530 calculates the number of target receivers and/or responders that received said message for charging said each advertisers based on matching at least part of message including keywords, metadata & attachments with each advertisement keyword(s), targeting criteria and contents;
         Step 6: Central unit FIG. 1-530 allowing each receiver to access message associate active link(s) or allowing each responder to send one or more response with or without active link(s) to sender or communicate with sender of message. E.g. said responder User [Hotel Ram] send response to target customer User [Y]=“I know the Pure Vegetarian Restaurant—Hotel Ram in NYC” and provide or attach with response one or more active links, e.g. Active Links: (1) MAP & Direction, (2) Hotel Ram;
         Step 7: Central unit FIG. 1-530 calculates the number of responses and communication of all responders of said message for enabling charging said each advertisers based on matching at least part of message including keywords, metadata & attachments and responses of message with each advertisement keyword(s), targeting criteria and contents;
         Step 8: Central unit FIG. 1-530 enables the sender of message to access said response and associate active link(s) e.g. User [Y] view the active links MAP & Direction for finding restaurant and access the active link Hotel Ram for advance book the seat in restaurant “Hotel Ram”; and
         Step 9: Central unit FIG. 1-530 tracks one or more actions by sender of message, receiver(s) or responder(s) of message and central unit on said message, related response(s) and active link(s) and based on that calculating number of actions, number of hits or clicks, amount of transactions, type of actions, interactions & transactions for charging said each advertisers based on matching at least part of message including keywords, metadata & attachments and responses of message with each advertisement keyword(s), targeting criteria and contents. E.g. e.g. User [Y] manually describes user actions i.e. (2): I visits and likes the restaurant, and provide comment (3) My Comments, and provide rank (4) My Rank and system also auto monitor, tracks, generates and records User Actions e.g. (1) User [Y] Book Seat via Hotel Ram based on user access of active link Hotel Ram and transaction for booking.
         All steps are not compulsory and fewer steps can take place, concurrent one or more steps in any order can take place and any sequence and combinations are possible.
(2) Public Messaging, Publishing & Status Updates Communication Channel, where user can subscriber & subscription of public message publication of any other users of network and search sources from public message content as describe in U.S. patent application Ser. No. 11/995,343, titled: “A method and system for communication, publishing, grouping, advertising, searching, sharing and dynamically providing a Journal Feed” and divisional U.S. patent application Ser. No. 12/973,370, titled: “A System and method for publishing, communication and real time searching”.
   Examples:
      (1) Publisher User [A] publishes message: “I like Movie “ABC”, my movie details, story and rating . . . ” and have 3 subscribers Users [X], [Y] & [Z] and all subscriber users receives all updated messages from said publisher user [A]
      (2) Publisher User [A] publishes message: This is my tour photos—Download Link(s): Collections of Photos and have 3 subscribers Users [P], [Q] & [R] and all subscriber users receives all updated messages including said from said publisher user [A] and download and view said photos by clicking on said attached link.
      (3) Status updated by User [A]: “Currently I am in New York city mall” and all subscribed user receives each updated status from said user.
(3) Auto generated Journal Feed Communication Channel in which system monitors, records, stores & filters user activities or actions and auto generates journal items or messages based on said activities and attaching one or more active links & apps and send to connected users of user, where active links or apps enables a user to participate in the same activity as another user as describe in U.S. patent application Ser. No. 11/995,343, titled: “Method and system for communication, publishing, grouping, advertising, searching, sharing and dynamically providing a Journal Feed” and divisional U.S. patent application Ser. No. 12/973,370, titled: “A System and method for publishing, communication and real time searching”.
   Examples:
      (1) Auto generated action messages of User Y: (1) “User Y install application WWW” where User Y is source of message or action doer, install application is type of user action or activity and WWW is an application that user install. Central unit monitors user's “install application activity or action” and each time generate message with said who-what-where-when-how of action and identified integrated objects or application links and present to connected or selected or matched users, wherein said links enables viewing user to participate same activity as of another user or source or subject user.
      (2) User Y join group ABC, wherein links enables viewing user to join said group.
   Central unit receives and stores each user of network, user profile(s), User selected and installed applications, communication channels & subscribed services for facilitating user's various activities and user connections including friends and friends of friends.
   Central unit or system monitors, records or logs or tracks, stores, ranks, indexes, filters & process user's filtered or selected or matched one or more actions, activities, To-Do, events, transactions including who, what, where, when, how, with whom about action and identify related and interacted one or more objects, profile(s), interactions, users, links, pages, media contents & data, applications, networks, groups, services identity in a network or from external domains like User [B], Brand ABC, User [A], Application—Game with accessible link indicating interaction source(s) or source(s) of action, message source (from), matched or selected or connected destination or viewing users, Action doer and auto generates and present said one or more generated messages to matched or selected or connected destination or viewing users.
(4) Service based social network Communication Channel where user provides one or more services to other users of social network including task, work, searching, sharing, marketing, advertising, communication services and user can subscribe one or more services of other users as describe in U.S. patent application Ser. No. 12/847,875, titled: “A System and method of Service Based Social Network and expert human mediated search engine”.
(5) Human mediated search engine services Communication Channel in which user send search query or question to one or more expert human agents based on auto matchmaking or user selection or determination and one or more expert human agents provided search result(s) or answer(s) to related searcher or asker. Central unit stores, indexes and process said search query and related responses and provides search engine to other users for searching contents as describe in U.S. patent application Ser. No. 12/847,875, titled: “A System and method of Service Based Social Network and expert human mediated search engine”, U.S. patent application Ser. No. 12/974,998, titled: “Div-12: A method and system for managing resources for providers” and U.S. patent application Ser. No. 12/975,016, titled: “Div-13: A method and system for requesting social services from group of users”.
(6) Unified & Integrated Communication Channel where user can create or initiate plurality of communications and attach & detach connected & selected users and communication applications including email, chat, IM and user can send request for joining one or more communications or invite other users for joining communication as describe in U.S. patent application Ser. No. 12/975,036, titled: “A method and system for integrated online communication and collaboration”.
(7) Publishing Communication Channel wherein user or system can dynamically publish and present user content and data as per subscriber users selection and preferences as describe in U.S. patent application Ser. No. 12/973,387, titled: “A method & system for publishing and subscribing in social network”.
(8) Sharing Communication Channel where user can share content from external domain to any communication channel and connected users of existing domain as describe in U.S. patent application Ser. No. 12/948,483, titled: “A method and system of sharing in a plurality of networks”.
(9) User created Group(s) and Dynamic Group(s) Communication Channel wherein user can create one or more public, private and shared groups for communication, collaboration, workflow, participating, searching & sharing and system dynamically creates one or more groups based on user activities, online availability, location, date & time and combination thereof for communication, collaboration, workflow, participating, searching & sharing as describe in U.S. patent application Ser. No. 11/995,343, titled: “Method and system for communication, publishing, grouping, advertising, searching, sharing and dynamically providing a Journal Feed” and divisional U.S. patent application Ser. No. 12/973,370, titled: “A System and method for publishing, communication and real time searching”.
(10) Search Macro Communication Channel in which system monitors, records, stores, indexes and process user's one or more keywords specific search process related sequences of actions & events and allow user to edit search process related one or more actions, events and providing said search macros to other users, connected users and subscribers as describe in U.S. patent application Ser. No. 12/847,853, titled: “A System and method for Creating, Searching and Using a Search Macro”
(11) Universal Desktop and Database Resource searching Communication Channel in which system send search query to matched user's desktop based on index data and users desktops act as distributed search server and matched or selected search results send to related searching user(s). Central unit also stores, indexes ranked and selected said searched contents and making them available to other users of network as describe in U.S. patent application Ser. No. 12/847,879, titled: “A System and Method for Universal Desktop & Database Resources Searching, Subscribing and Sharing” and U.S. patent application Ser. No. 12/853,108, title: “A system and method of peer to peer network”
(12) Advertisement Communication Channel in which advertisers and relevant and matched users of network can interact, communicate, transact with each other as describe in U.S. patent application Ser. No. 12/973,351, titled: “A method & system for Intelligent Targeting of Advertisements” and U.S. patent application Ser. No. 12/847,840, titled: “A system and method of targeting advertisements and providing advertisements management”
(13) Brands Social Network Communication Channel in which user selects or inputs brands and identification data based on relevant templates and system creates public, private and shared networks based on said brands and identification data for e-commerce, review, communication, collaboration, workflow, participation, searching & sharing as describe in U.S. patent application Ser. No. 12/954,564, titled: “A METHODS AND SYSTEMS FOR BRANDS SOCIAL NETWORKS (BSN) PLATFORM”.
   Other Communication Channels:
(14) Network(s) Communication Channel where users can join or create one or more networks for communication, collaboration, workflow, participation with other users' activities, searching & sharing within network(s).
(15) Searching Communication Channel in which user can initiate search process and system auto matching online related users including connected users for searching & sharing search result collaboratively,
(16) Video & Photo Sharing Communication Channel wherein user can share refers, view, upload one or more videos and provide ranking or rating and comments. System also monitories, records, filters and stores user's video related activities and actions including viewing particular video, uploading video, commenting and rating a video and auto generating messages and attaching links of video and source user with said video related user's activities and sharing with other connected or filtered users of user, so other user can view said video or read comments & rating on video.
(17) Messaging Communication Channel in which user can post one or more messages including any media data like text, video, link or URL, video, photo to selected and connected users of network.
(18) Application & Service Specific Communication Channels including News, Blog, E-commerce, Search, Share, Tasks, Work, Finance, Travel and like.
(19) New and existing known & available Communication Channel from central unit and 3^{rd} parties' developers, service providers and users.
(20) One or more Combination of Communication Channels

User can select or switch and use one or more or combination of Communication Channels for providing responses to related Active note(s) provider(s).

System can also provides application framework to user, so user can search, share and install one or more applications from central unit FIG. 1-530 & one or more developers and service providers and share application data with one or more connected users based on privacy settings as describe in U.S. patent application Ser. No. 12/847,861, titled: “A System and Method for accessing applications for social networking and communication in plurality of networks”

System can dynamically and selectively apply privacy setting for one or more user profiles, user data or content, communication channels, applications and services as describe in U.S. patent application Ser. No. 12/948/495, titled: “A systems and methods for dynamically generating a survey result(s)”, U.S. patent application Ser. No. 12/975,046, titled: “A method and system for sharing user and connected users' data with external domains, applications & services and users' and “A System and Method for publishing, sharing and accessing selective contents in a Social Network”

System maintains in a database a plurality of nodes of a social graph, plurality of connections in the social graph, where each connection represents a connection between two or more nodes in the social graph and maintaining in database information about one or more of the nodes and connections. Each node of social graph is identified by unique namespace. System dynamically updates connection information between nodes based on user's activities, actions, interactions, events and transactions with other nodes including connected and matched users, objects, applications, services, media data & contents, identities, pages, links and other objects from network. User can search, select, access and share one or more links of nodes with other nodes on network, wherein link or namespace enables other users to access and invoke link associate one or more resources, applications, services, media data, objects, profile, page, communication channels and like as describe in U.S. patent application Ser. No., titled: “A System and Method for generating and updating information of connections between and among nodes of social network”

FIG. 3 illustrates an exemplary user selected 60 tree style user interface or view i.e. GUI 70 for presenting all Active Note(s), related Response(s) and communications data related to user selected Active Notes communication channel 280 in tree-branch format 70. Active Notes are represented in a tree-branch configuration such that new responses added to each Active Note(s) are associated directly to the existing Active Note(s) to which they respond. Branches can be opened or collapsed automatically or at the users' option, allowing the user focus his attention on selected Active Note(s) & related Responses and communication. The user can close any branch of the conversation by clicking an icon with a ‘minus sign’, which collapses that comment and any detail that falls below it. After the user clicked the minus sign, the minus sign icon it changed to ‘plus sign’ and a line appeared, indicating a collapsed comment or branch in the conversation. Clicking that plus sign icon expands the conversation view back to the state shown in FIG. 3 (70). Expanding and collapsing branches of the conversation tree can be done in an automated fashion as well. User can expand all and collapse all branches of tree.

User can also act as responder and provide response for Active Note(s). User receives all Active Note(s) from connected users under (Active Notes from Connected Users Tab), from one or more categories lists or groups of users under (Active Notes from Lists of Groups of Users Tab), from subscribers under (Active Notes from Subscribers Tab), from Public based on one or two way matchmaking user preferences under (Active Notes from Public Tab), user receives Active Note(s) transfer or assigned from other users or responders or service providers for providing one or more responses to related Active Notes Providers by using Response Provider Management 180.

User can select one or more Active Note(s) and related one or more Responses or Messages and apply or do one or more actions 290 (more detail in FIG. 4—1330), allow sender and receiver of active note (message) to take one or more actions on each active note (message), related responses and active links wherein said actions comprising attach or detach receivers or responders, active links, group members and forward, transfer, assign, search, match, share, filter, sort, order, group, categories, bookmark, add, update, delete one or more active notes, related each responses and active links, view logs, actions, transactions, events, activities & communications details, report spam, abuse & violation, set tracking status, provide comments & ranks, communicate with sender or receiver of messages, accessing of active links related each action details and provide user defined or auto recorded action details.

FIG. 3 illustrates an exemplary tree style GUI 70 for presenting to user Active Notes & Responses communication channel related Active Note(s) 80 & 120 or messages & communication data with metadata, categories, attached active links, applications, application features, services, multimedia data, date & time of sending Active Note(s), list of one or more responders & associate metadata, source of Active Note(s) or messages or communication including sending from mobile, sending from external domain, web site, application, services, network, device, sending from particular communication channel(s) like Active Note(s) communication channel, journal feed communication channel. User can take actions or To-Do 290 on each selected Active Note(s) or messages or communication. Each parent Node displays an Active Note(s) 80 & 120 or message or communication and related each child or branch node displays response(s) (70—1 to 5). Each Sub-branch node displays each response related further communication by using various applications and communication channels including text, instant messaging, chat, email, new types of communication channels and like. FIG. 3 (70—1 to 5) shows various responses from plurality of sources or responders related to Active Note(s) or messages & communication 80. Each response may comprise response from one or more responder(s) including auto responses 110 from central unit FIG. 10-530 and group responses 100 from group of categories users in text, video, image or any types of media data and attached with metadata, categories, concept name or type, keywords, date & time of responding, further communication related details & logs, source(s) of response(s) including mobile, from external domain, web site, application, service & network, attached one or more active link(s) or apps or services by responder(s) for participating, communication, collaborating, transacting and other user actions or operations with one or more responders, service providers, groups, networks applications and users, displaying the list of one or more user provided or auto generated actions on each response including tracking status like pending, read and user ratings, user comments, purchase brand by user that suggested by responder, viewed or read or played media data by user that send by responder(s), booked ticket or hotel room by user with the help of attached active link(s) or active application(s) that provided or facilitated by responder or service provider, installed application by user based on received auto generated message from connected users related to one or more activities, join particular group by user and manual user actions provided by user including shopping by me, not like particular brand, attend exhibition, viewed movie, eat food at restaurant provided by responder, visits museum, purchase book from particular events provided by particular connected user and like and any other user provided or auto logged or recorded user actions based on Active Note(s) or message or communication related response and response attached one or more active link(s) or apps or services.

FIG. 3 illustrates an exemplary GUI 180 for Response Provider Management where user or responder or service provider can prepare, manage and send one or more responses to one or more related Active Note(s) providers. Responder user or service provider can search & select already exist active links, applications, services and/or upload one or more domain or field or subject or professional or expertise specific applications or services for providing domain or field or professional specific Active Note(s) related response to Active Note(s) provider. Responder user or service provider can attach one or more active links or apps or apps features or services with response for said received one or more messages, wherein said attached active links or applications or services enabled response receiver or Active Note(s) provider(s) to communicate, collaborate, share, search, workflow, take one or more actions, transact and participating activities of responder(s).

Active note(s) Provider & Responder can attach one or more active applications & links with Active Note(s) & Response(s) FIG. 3—190 & FIG. 4—1310. Active note(s) Provider & Responder can search select and add to list one or more related active applications & links from central master list and upload one or more active applications & links. Active note(s) Provider & Responder can create one or more categories list. For example Active note(s) Provider & Responder can create separate list for Active note(s) and providing response. List auto generated or user created may based on Active note(s) Provider & Responder's expertise fields, education & qualification, profession, service, interest, activities, connection, preferences, age, gender, income range, location, language, purpose, requirement, group(s), network(s) including school, collage, work & like, random selection, Active Note(s) content or text, type(s), categories, metadata, Active Note(s) Provider profile & data, past responses & experience.

Active note(s) Provider attach one or more active applications & links with Active Note(s) from list FIG. 3—190 & FIG. 4—1310, wherein said one or more active applications & links enables response providers to provide response, participating same activities as of Active Note(s) provider, communication, collaboration, group discussion, e-commerce, transactions, provide support services, answering, marketing, advertising, referring, selling, sharing, publishing any Active note(s) purpose specific or related one or more active applications & links. For example Active Note(s) Provider attach “Sell Mobile” link which enables receiver user to buy mobile, attach Install Application(s) link which enables receiver user to select & install applications that installed by or suggested by sender, attaching Join My Group link which enables receiver user to join same group as of sender user, attaching Answer My Question link which enables receiver user to answer the question of sender. Thus ready to use one or more active applications & links enables responder to provide any types of response or participate or take actions on one or more active applications & links related to Active Note.

Likewise responder or receiver of Active note(s) Provider can attach one or more active applications & links with Active Note(s) from list FIG. 3—190 & FIG. 4—1310, wherein said one or more active applications & links enables Active note(s) Provider to buy something, transact, ecommerce, participate same activities as of responder or receiver of Active note(s) Provider, communicate, collaborate, discuss, consume services, view answer, advertising 7 attachments, share and any Active note(s) purpose specific or related one or more active applications & links. For example responder or receiver of Active note(s) Provider can attach “Book Hotel XYZ” link which enables Active note(s) Provider to book hotel, attach Listen & Download Music(s) link which enables Active note(s) Provider to listen or download preferred music based on Active note(s) Provider's Active note(s), requirement, purpose, solution, activities, actions, events, interest, workflow, task, entertainment, health issue, complaints, how-what-where-when-which related things, search, news, blogs, publication, answer for question, discussion on particular topics, direction & map, purchase & transaction requirement, information, application, service, user actions on response, user attached active links & apps, auto & manual or human mediated analyzing & interpreting Active Note(s) text data and metadata.

Active note(s) Provider & Responder can draft and/or attach one or more resources 200 with Active Note(s) or message or communication and Responses including Text, Links, Photos, Videos, Docs, Search Results, Structured Resources, Form(s) based resources, Draft resources by using full features Editor, Response Templates & Concept Templates and associate one or more metadata.

Active Note(s) Provider(s) & Responder(s) can use one or more communication applications 210 for providing one or more responses and communication with message(s) sender(s) or Active Note(s) provider(s) and other Responders, wherein communication applications comprising Instant Messaging (IM), Chat, E-mail, VoIP, shared Workspace, Applications, Groups, Networks and other customize Applications & services. User can also search and add or install one or more communication applications.

Responder can use one or more communication channels 280 for providing one or more responses to message(s) sender(s) or Active Note(s) provider(s).

Active Note Provider User can take one or more actions or To-Do 290 on one or more selected Active Note(s) and/or Responses including Attach one or more active applications & links from list of active applications & links based on user selection or auto selection, Send one or more Sub Notes, Send Further Details or Clarifies Active Note(s), further communication with responder(s), Attach & Detach Responders, Attach & Detach Group Members, Attach & Detach Applications, Forward or Route Active Note and/or Response to selected users and/or providers for collaborative responses, Share Active Note and/or Response, View Transaction Details or Logs or communication details on Active Note(s), related responses and active links & applications, view Auto Action Details monitored, record, store, filter & logged automatically by central unit FIG. 1-530 based on user actions on Active Note(s), related responses & active applications & links, Report Spam, Abuse and violation to central unit FIG. 1-530 for blocking & removing responders, Set Tracking Status or View auto Tracking Status by user, Provide one or more Comments on response(s), Provide Rank or Ratings to response(s) and Sort, Filters, Group, Categories, Delete and Bookmark one or more selected Active Note(s) and/or responses & communications, User Action(s) or To-Do on Response(s) can selected from Templates, Input by user manually and auto generated or selected or inputted by system or central unit FIG. 1-530, select Active Note(s) and/or responses and take one or more group actions or operations on them including sort, delete, share, rate, bookmark and Update & edit Active Notes and/or Responses.

Likewise responder user(s) can take one or more actions or To-Do 290 on one or more selected Active Note(s) and/or Responses including Attach one or more active applications & links from list of active applications & links based on user selection or auto selection, Send one or more responses, Send request for further details or clarification of Active Note(s), further communication with Active Note(s) Provider(s), Attach & Detach Group Members for providing response(s), Attach & Detach Applications, Forward or Route or assign or transfer Active Note(s) and/or Response(s) to selected or connected users and/or service providers and/or responders for providing collaborative responses, Share Active Note(s) and/or Response(s) with other connected, subscribed, responder users, View Transaction Details or Logs or communication details on Active Note(s), related responses and active links & applications, view Auto Action Details monitored, record, store, filter & logged automatically by central unit FIG. 1-530 based on responder actions on Active Note(s), related responses & active applications & links, Report Spam, Abuse and violation to central unit FIG. 1-530 for blocking & removing Active Note(s) Provider(s), Set Tracking Status or View auto Tracking Status by responder user, Provide one or more comments on Active Note(s), Provide Rank or Ratings to Active Note(s) and Sort, Filters, Group, Categories, Delete and Bookmark one or more selected Active Note(s) and/or responses & communications, Responder Action(s) or To-Do on Active Note(s) & Response(s) can selected from Templates, Input by user manually and auto generated or selected or inputted by system or central unit FIG. 1-530, select Active Note(s) and/or responses and take one or more group actions or operations on them including sort, delete, block, unsubscribe, share, rate, bookmark and Update & edit one or more responses.

Response Provider Management also provides various integrated search options 220 to responders for providing one or more responses to Active Note(s) provider(s) message(s) sender(s) including Search Past Responses/Concepts, Search and Subscribe keyword(s), categories specific resources including matched Active Note(s) & related responses from central unit FIG. 1-530, Search from one or more Providers, Search from Connected Users, Search from Other Sources including deep databases, internet, service providers and search engines like Google, Search User(s) & Connected Users Profiles & user Data including selective Life stream resources and search and add various customized search applications for preparing and providing response(s).

User can save each response 240 and/or send 260 each response to related one or more Active note Provider users. Responder or Active Note receiver user can manage all saved or pending to send and already send responses related to plurality of active notes by using Response Explorer 250. Response Explorer categories each Active Note Provider specific Active Notes and related response(s), so responder can search, sort, view, share, transfer, send, filter, bookmark, order, schedule for sending to active Note Provider(s), edit or update, delete one or more Active Note related responses, attach one or more active links & apps (FIG. 2-190 & FIG. 3-1210) and take one or more actions (FIG. 2-290 & FIG. 3-1230) on response(s) and set rank or rating, provide comments on Active Note(s) & Active Note Provider(s).

User can manage connections, subscribers and subscriptions (FIG. 3-160 & FIG. 4-1390) via searching known connection from network, importing contacts from external sources and search connected users from network, selecting or adding connections from suggested users, searching like minded or matched users from central search engine including search and/or subscribe responders 140 and active note providers 150. User connections comprising (FIG. 4-1390) one or more or categories list of Friends & Family Members, Friends of Friends (N-Degrees of separation), Subscribers, Group(s) Members, Network(s) Members including connections from Class, School, Collage, Workplace, Organization, Club networks, added connections by searching and selecting users from central search engine, Matched Users based on one or two way match making preferences, selected users from Suggested list of users, Dynamically created Groups Members, Responders or Providers including Users, domain or subject or brand specific Experts & Service Providers and Applications & Service Providers, Bookmarked users, list of Invited users and Auto matched users based on user preferences, user profile & data, location, interest, transaction, rank.

User can search, select, install one or more applications and subscribe services from central unit FIGS. 1-530 and 3^{rd} parties' application developer and service providers via central unit FIG. 1-530 comprising collaborative games, travel, finance, Question & Answer, Quiz, Classified, Marketplace, College Network Management, School Network Management, Album, Notes, Top Friends, Tech News and user can also publish or share list of applications to connected users for sharing, communication, collaboration, participation, searching, supporting, providing response to other users and social network related applications. Connected users of each user can see user installed said one or more applications and install or participate with one or more applications of one or more connected users. User can selectively share profile(s), user data and application(s) data with other users based on one or more privacy settings. User can also invite other users for participate with user's activities via one or more applications. For example a user install game related application and invites other connected or matched users for playing game, installs collaborative search application and invite other connected or matched users for searching search query collaboratively from one or more sources, install one or more communication channels and allow other user's to subscribe or allow connected user's to participate with said one or more communication channels for communication, collaboration, searching, participating, sharing and providing user services and user generated contents.

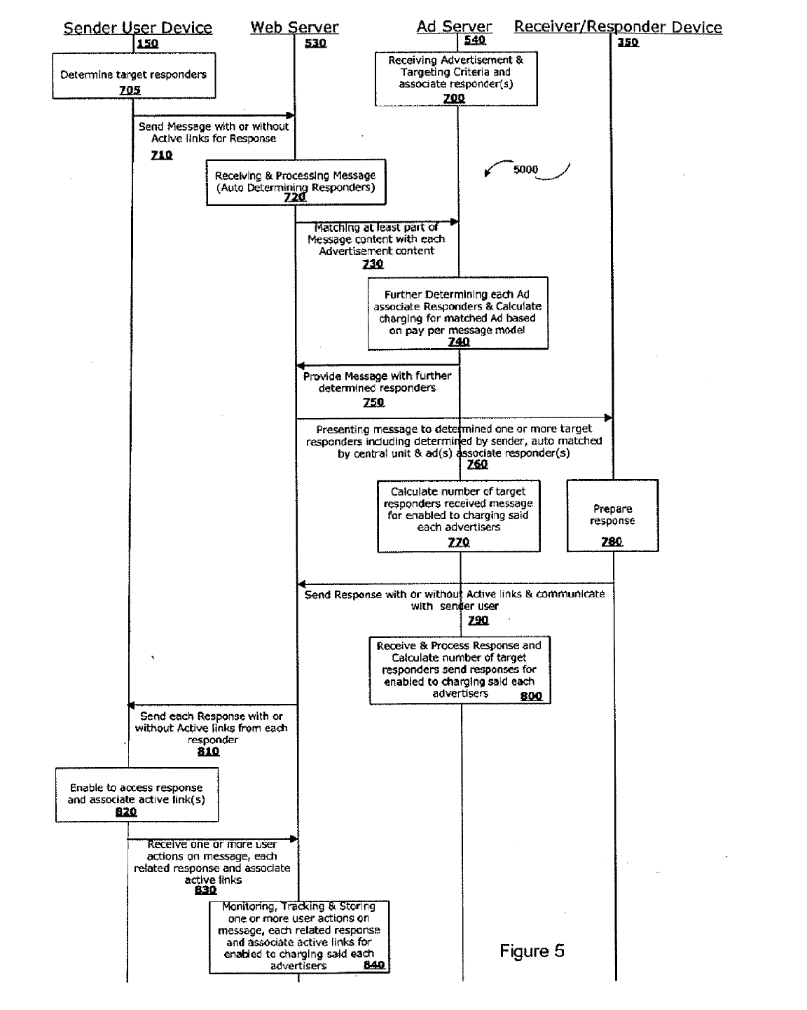

FIG. 5 illustrates a process for zero click advertisement in accordance with one embodiment of the invention. In this embodiment, the process for zero click advertisement is used for a social networking website 100. In a first step, receiving plurality of advertisement requests 700 at Ad server 540 coupled to the web server 530 of the social networking web site 100, each advertisement request comprising an advertisement, advertisement content, targeting criteria and one or more responders on behalf of advertisers and storing said advertisement request data at advertisement requests data store 545 to receive one or more active notes (messages) from target customers of the network based on matching at least part of each active note (message) posted by each user including keywords, metadata & attachments with each advertisement keyword(s), advertisement, targeting criteria and contents. Sender 150 can send or post 710 an active note (message) with or without active link(s) or auto send by central unit (web server 530) to one or more determined 705 target receivers and/or responders 350 by sender 150 and/or to auto determined by central unit (web server 530). Web server 530 receives said active note (message) and process 720 said active note (message), wherein said process of active note (message) comprising matching 730 at least part of active note (message) including keywords, metadata & attachments with each advertisement keyword(s), targeting criteria and contents at Ad server 540 for enabled to further determine responders 740 including send or present active note (message) to each matched advertisement associate responder(s) and charging 740 each matched advertisement or advertiser based on pay per advertisement related keyword(s) matched in each active note (message) of each sender user and receive said matched & relevant active note (message) from target customers. Process 740 of Ad server 540 provides active note (message) with further determined responders 750 to web server 530. Web server 530 send or present 760 said active note (message) to determined one or more target receivers and/or responders 350 including one or more responders associate with said matched advertisement content, determined by user and auto matched by central unit and web server 530 calculates the number of target receivers and/or responders that received said active note (message) for enabled to charging said each matched advertisements. Web server 530 allows each receiver 350 to access said active note (message) associate active link(s) or allow to each responder 350 to prepare 780 and send 790 one or more response with or without active link(s) to sender user device 150. Web server 530 calculates the number of responses and communication of all responders of said message for enabled to charging said each matched advertisements and send 810 response with or without active links from each responders to sender user device 150 and enable sender 150 of active note (message) to access 820 response and associate active link(s) and receiving 830, monitoring, tracking & storing each actions 840 taken by sender 150 of active note (message), receiver(s) or responder(s) 350 of active note (message) and central unit (web server 530) on said active note (message), related response(s) and active link(s) and based on that calculating 840 number of actions, number of hits or clicks, amount of transactions, type of actions, interactions & transactions for enabled to charging said each matched advertisements.

Advertiser can post advertisements with advertisement contents which are stores at Advertisement request data store 545 comprising one or more target criteria, keywords, brand name(s), identities, product and service name, location, language, details, description text, media data including URL or links, video, image, documents, associate registered active links, list of responders, daily budget of advertisement, bid amount for particular keyword(s).

Advertisement associate one or more active links enables user(s) to buy & sell products, make payment or transaction, communicate, collaborate, view presentation or media data, search, share, participate, workflow, refer to other users, e-commerce, make order, book tickets, view said advertisement, make deal, bidding for products and services, join group, install application, receives discount vouchers, fill survey forms, subscribe newsletters, bookmark product(s) or service(s), negotiate with advertiser, managing buying and selling process or activities.

In one embodiment, enable to charging to advertisement of advertiser further based on list of responders mentioned in advertisement content receives number of messages, wherein message or part of message matched with said advertisement content.

In an embodiment, allow responder to present one or more active links mentioned in said advertisement based on matching part of message or keywords and metadata & attachments of message with each advertisement keyword(s), targeting criteria and contents and allow to attach said one or more active links with response for said message.

In an embodiment, wherein enable to charging to advertisement of advertiser further based on active links mentioned in advertisement content clicked by responder or response receiver.

In an another embodiment, wherein enable to charging to advertisement of advertiser further based on number of times message, related response(s), associate active links share and forward to other users of network by sender(s) and/or responder(s) including connected & matched users, subscribers, other responders.

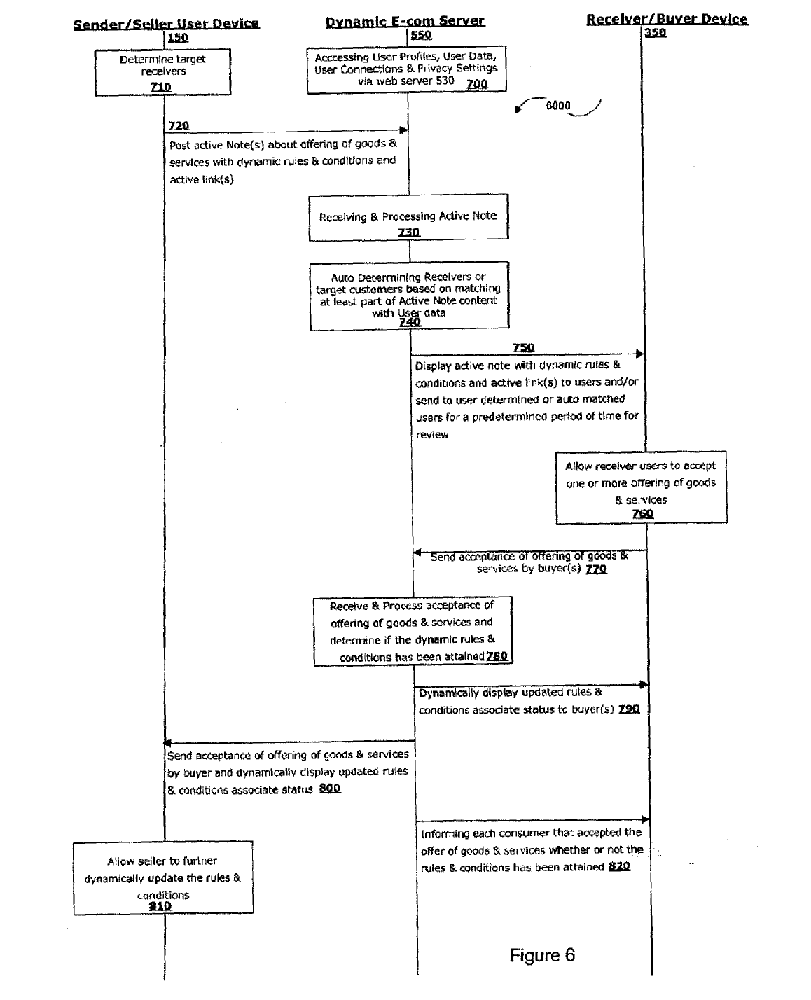

FIG. 6 illustrates a process for dynamic e-commerce in which an offer does not become valid until associate dynamic rules & conditions attained in accordance with one embodiment of the invention. In this embodiment, the process for dynamic e-commerce is used for a social networking website 100. In a first step, web server 530 enables dynamic e-commerce server 550 of the social networking website 100 to access 700 user profiles, user data, user connections with other users and privacy settings that store in user profile store 570 and user data store 580. Dynamic e-commerce server 550 allow seller or sender of active note(s) 150 to post active note(s) 720 about offering of goods & services with one or more dynamic rules & conditions and active links. Dynamic e-commerce server 550 receives & store said posted active notes in dynamic e-commerce data store and process said active note. Web server 530 coupled with dynamic e-commerce server 550 display 750 said active note(s) with one or more dynamic rules & conditions and active links over a network and send 750 said active notes to user determined 710 or auto matched users 740 of network for a predetermined period of time for potential buyers 350 to review. Dynamic e-commerce server 550 allow said target receivers or potential buyers 350 to receive said active note and/or allow users 350 to search, browses, select, bookmark, forward said active note(s) about offering of goods & services and allow users 350 to accept one or more offering of goods & services 760. Some users 350 accept 760 the offering of goods & services by said active note(s) and send acceptance of offering of goods & services 770 to Dynamic e-commerce server 550. Dynamic e-commerce server 550 receives said acceptance 750 of offering of goods & services by buyer users over the network for the predetermined period of time and determines if the dynamic rules & conditions has been attained 780. Dynamic e-commerce server 550 dynamically display updated rules & conditions associate status to buyer users 350 and send 800 acceptance of offering of goods & services by buyer 350 to seller 150 and dynamically display updated rules & conditions associate status and allow seller 150 to further dynamically update the rules & conditions 810 and informing each buyer or consumer that accepted the offer of goods & services whether or not the rules & conditions has been attained 820.

Dynamic rules & conditions based on determined number of purchase or determined amount of purchase or determined duration within which purchase made or determined number of times purchases by buyer or group of buyers, total sale in particular duration, date & time range, location, income range, education & qualification, age range, gender, number of buying requests, number of points earned by user or group of users, one or more customize & user defined preferences, rules and conditions and any combination thereof at which time the discount offer price becomes valid.

Dynamic rules & conditions comprising user's actions & activities, transactions, current location, and events at which time the discount offer price becomes valid. User's action & activities comprising participating with brand social network by user, win sports & contests, play game and achieve scores by user, pass in exam & get particular percentage of marks or scores, join group by user, install application, subscribe service, fill survey form(s), provide rank & comments, refer, sell, resell, communicate, forward active note(s) to one or more connected users by user. User's transactions comprising number of transactions, amount of transactions in particular duration, transaction by referred, connected users and any combination thereof. User's events comprising user's birthday, anniversary, festival, holiday, seasons, any event days, trigger of any events defined by buyer and seller, trigger of events by system including current like minded or matched online users or prospective customers.

In an embodiment, Determining a geographic location of the identified devices; and applying rules & conditions based on current location of one or more or group of users including private or public events like concert, tradeshows, business meetings, sporting event, weddings, rallies, tourist place, work place & class room and number of users at particular location, where the geographic location is provided by an access device or based on the location of an access device.

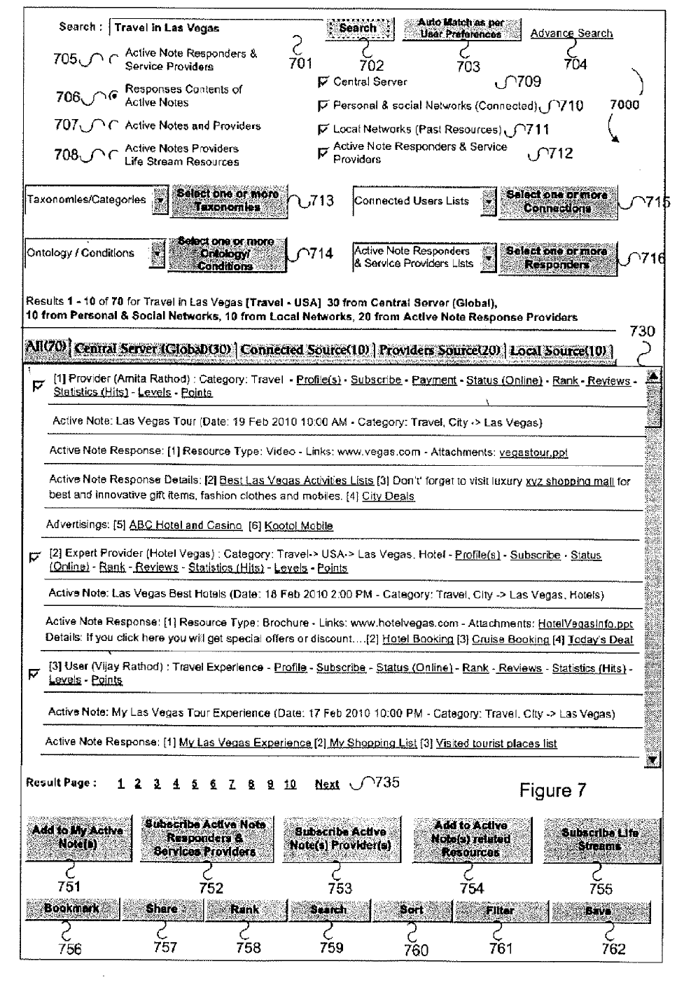

FIG. 7 illustrates example of graphical user interface (GUI) 7000 for the central server search engine. Registered user or active note(s) provider(s) and active note(s) responder(s) or viewers (Non-Members), and other uses may employ a search interface; one embodiment of screen 7000 is illustrated in FIG. 7 as an example.

Active note(s) provider(s) can search 702 or match as per preferences 703 one or more active note response contents 706 and active note response providers 705 by entering one or more keyword(s), user name or identities (ID), search query, phrases, Boolean operators or commands or conditions or rules to the search box 701. User can also filter or further limit what is displayed. Just use the filters available on the page to target results. Using the filters will limit results related to one or more selected categories, taxonomies 713, ontology, metadata, controlled vocabulary, rules and conditions 714, connected users 715, active note responders & service providers' lists 716. User can also select one or more sources of searches including search from global central server 709 and/or user's personal or social network(s) 710 and/or local network(s) 711 and/or selected one or more connected users and/or active note responders & service providers' lists 712. Then user can select one or more active note responders & service providers' lists for bookmarking 756 and/or subscribing the selected sources 752. User can search and select active note(s) specific one or more active responses 706 and add to the active note(s) related list of responses & resources 751. User can also share 757, rank 758, sort 760, save 762 and filter 761 the said selected active note responses & resources and active note response providers. Search results 730 display as per source clusters including central server, selected connected users, providers and local sources and tab interface facilities the user for switching from one tab to other tabs. Each search result of search results related to active note responses shows profile(s) link(s), name or user ID, categories, online status, rank, reviews or comments, hit statistics, levels & points and associate active note and related one or more active note responses with metadata including date & time, resource type, one or more taxonomies, ontology, categories, attachments, web links, source, advertisements and like. Search results divided as per number of search results per page in to number of pages and user can navigate from one page to others 735. User can Sort 758 results 730 by recently updated, category wise, time & date wise, location wise and popularity wise including hits, visits, ranks. Searches can also allow wildcards. User or active note responders or response providers or service providers can also employ advance search engine for providing one or more parameters or criteria like location(s), language(s), date & time range, one or more categories or selection for lists, rank and like 704.

User can click-through entry on search results list, resources from central server can then appear under “Central Server” tab, resources from selected connections can appear under “Connected Source” tab, resources from providers appear under “Providers Source” tab and resources from local PC or application or network can appear under “Local Sources” tab. Moreover, administrators, or the like, are able to search for users by username, or by email address (either of these can allow wildcard searches), or by some combination of Type (user, member, expert or admin) and Source, as defined by drop downs, or the like.

User can also search other users public life stream(s) sources & contents 708 and subscribe to one or more selected life stream(s) updates 755.

Active note response providers or service providers can search 702 one or more active note(s) and/or active note(s) provider(s) 707 by entering one or more keyword(s), User name or ID, search query, phrases, Boolean operators or commands or conditions or rules to the search box 701. Provider's can also filter or further limit what is displayed. Just use the filters available on the page to target results. Using the filters will limit results related to one or more selected categories, taxonomies 713, ontology, metadata, controlled vocabulary, rules & conditions 714. Provider's can select one or more active note(s) or subscribe to active note(s) provider's active note(s) updates for providing one or more responses with active links 753.

Active note response providers or service providers can also search other Active note response providers or service providers 705 for collaboration and search, select and add active note(s) specific responses with active links 706 and can search active note(s) provider's profile(s) 707 & public life stream 708 from the central for better understanding active note(s) and active note(s) provider(s). Provider can also share 757, rank 758, sort 760, save 762 and filter 761 the said selected active note responses and providers and/or active notes and providers. Provider can sort 758 results 730 by recently updated, category wise, time & date wise, location wise and popularity wise including hits, visits, ranks.

Each search result of search results related to active note(s) shows profile(s) link(s), name or user ID, categories, online status, rank, reviews or comments, hit statistics, levels & points and associate active note and related one or more active responses with active links with metadata including date & time, resource type, one or more taxonomies, ontology, categories, attachments, web links, source, advertisements and like. Search results divided as per number of search results per page in to number of pages and user can navigate from one page to others 735.

1-70. (canceled)

71. A method of dynamic deals and/or dynamic-commerce in which an offer does not become valid until associate dynamic rules & conditions attained, comprising a network server, a microprocessor, a memory and computer software, said computer software being located in said memory and run by said microprocessor, said computer software comprising a dynamic deals and/or dynamic e-commerce algorithm, wherein said dynamic deals and/or dynamic e-commerce algorithm comprises the steps of:
enabling seller to post dynamic deals about offering of goods & services including associated dynamic rules & conditions
display said dynamic deals about offering of goods & services including associated one or more dynamic rules & conditions and active links over a network and send said active notes to user determined or auto matched users of network for a predetermined period of time for potential buyers to review;
enabling said target receivers to receive said active note and/or allow users to view, search, match, select, bookmark, forward to connected or related users and/or receive said dynamic deals about offering of goods & services;
enabling users to accept one or more offering of goods & services;
receiving of acceptance of offering of goods & services by buyer users over the network for the predetermined period of time;
determining if the dynamic and/or updatable rules & conditions has been attained;
allow to further dynamically update the rules & conditions; and
informing each buyer that accepted the offer of goods & services whether or not the rules & conditions has been attained.

72. (canceled)

73. The method according to claim 71, wherein dynamic rules & conditions comprising user's actions & activities, transactions, current location, and events at which time the discount offer price becomes valid.

74. The method according to claim 71, wherein said user's action & activities comprising participating with brand social network by user, win sports & contests, play game and achieve scores by user, pass in exam & get particular percentage of marks or scores, join group by user, install application, subscribe service, fill survey form(s), provide rank & comments, refer, sell, resell, communicate, forward active note(s) to one or more connected users by user.

75. The method according to claim 71, wherein said user related transactions comprising number of transactions, amount of transactions in particular duration, transaction by referred, connected users and any combination thereof.

76. The method according to claim 71, wherein said user's user related events comprising user's birthday, anniversary, festival, holiday, seasons, any event days, trigger of any events defined by buyer and seller, trigger of events by system including current like minded or matched online users or prospective customers.

77. The method according to claim 71, wherein determining a geographic location of the identified devices; and applying rules & conditions based on current location of one or more or group of users including private or public events like concert, tradeshows, business meetings, sporting event, weddings, rallies, tourist place, work place & class room and number of users at particular location, where the geographic location is provided by an access device or based on the location of an access device.

78-129. (canceled)

130. The method according to claim 71, wherein said dynamic deals comprising one or more attached or associated active links.

131. The method according to claim 130, wherein said active links enables receiving users but not limited to buy or bid or gift or trade or make payment for deals, referee or share deals to connected or related users, provide reviews, comments & ranks to deals and/or provider of deals, bookmark deals, communicate, collaborate & participate with deals providers and other deal associate users and/or negotiate with deals providers, download & install application, subscribe service(s) & multimedia contents, provide preferences, privacy settings & fill survey forms, receive coupons & discount vouchers, subscribe to one or more types or categories of deals and/or deals provider(s), managing deals associate with deal provider including user profile, preferences, privacy settings, accounting, user activities, group(s) & social network(s) and enables plurality types of dynamic, customized, accessible, contextual, & portable application features, services and objects.

132. The method according to claim 71, wherein further enabling provider of dynamic deals to dynamically updating of the dynamic rules & conditions.

133. The method according to claim 71, wherein dynamically display updated dynamic rules & conditions and associated dynamic & updated status to users or deals buyers or deals viewers.

134. The method according to claim 71, wherein enabling server to determine or matchmaking of dynamic deals receivers.

135. The method according to claim 71, wherein enabling seller to determine target receivers of dynamic deals.

136. The method according to claim 71, wherein enabling user to determine receiving of dynamic deals.

137. The method according to claim 71, wherein enabling matchmaking of dynamic deals providers and prospective buyers, consumers and users.

138. The method according to claim 134, wherein said determination are based on but not limited to user or group(s) of users' connections & relationships, user profile, preferences, privacy settings, matchmaking preferences of users and/or deals providers, user data, location or place, language, user subscriptions of deals providers, searching initiated by user or search queries, user selections, referring, sharing, current common or similar location or place and/or event and/or date & time of group(s) of users, user or group of user(s) activities, activities types, actions, participations, behavior, status, senses, events, transactions and online availability.

139. The method according to claim 71, wherein said received, sent, and presented contents associated one or more active links enables user(s) to buy & sell products, make payment or transaction, communicate, collaborate, view presentation or media data, search, share, participate, workflow, refer to other users, e-commerce, make order, book tickets, view said advertisement, make deal, bidding for products and services, join group, install application, receives discount vouchers, fill survey forms, subscribe newsletters, bookmark product(s) or service(s), negotiate with advertiser, managing buying and selling process or activities.
